(19) United States
(12) Patent Application Publication
(10) Pub. No.: US 2020/0342397 A1
(43) Pub. Date: Oct. 29, 2020

(54) HOUSING INFORMATION PROVIDING SYSTEM

(71) Applicant: SHUHEI HARA, Tokyo (JP)

(72) Inventor: SHUHEI HARA, Tokyo (JP)

(21) Appl. No.: 16/396,189

(22) Filed: Apr. 26, 2019

(51) Int. Cl. G06Q 10/08; G06Q 10/02; G08G 1/127

(52) U.S. Cl. CPC G06Q 10/0836; G08G 1/127; G06Q 10/02

(57) ABSTRACT

In a delivery service of delivery objects, to provide a housing information providing system that allows a delivery person who delivers the delivery object to easily confirm information of a housing device so as to smoothly carry out the delivery business. The housing information providing system is constituted by housing device that is capable of housing a delivery object in a housing box, a managing server for managing housing information including usage situation of the housing box of the housing device and a delivery person terminal that is operated by a delivery person who actually carries out delivery business of delivery objects.

### STATEMENT REGARDING PRIOR DISCLOSURE BY THE INVENTOR

Japanese Publication No. 2018-072885 dated May 10, 2018 is a grace period inventor-originated disclosure which qualifies as an exception under 35 USC § 102(b)(1).

### TECHNICAL FIELD

The present invention relates to a housing information providing system, and in particular concerns such a housing information providing system as to provide information relating to usage situation of a housing device to a delivery person for carrying out delivery business on the housing device.

### BACKGROUND ART

Condominium houses such as apartments or the like are divided into a commonly-used part serving as a space that can be commonly used by residents and a privately owned-part that is a private space for each resident and cannot be used by other residents.

The commonly-used part includes, for example, an entrance, elevators and the like of the condominium houses.

The privately owned-part includes, for example, respective homes of the condominium houses.

In recent years, in the commonly-used part or the like of the condominium houses such as apartments or the like, housing devices for home delivery objects that are so-called home delivery lockers are installed in many cases.

Each of these housing devices for home delivery objects is provided with a plurality of housing boxes that can be commonly used by residents, and by the commonly used housing boxes, a delivery object that is delivered to any address of a resident of the condominium houses by a delivery service or the like is temporarily deposited or lockably housed so that even when the corresponding resident himself or herself is not at home, he or she can receive the delivery object smoothly without the necessity of asking for re-delivery.

Moreover, any resident can deposit clothes or the like for laundry in the housing box, and a laundry agent collects the deposited clothes, and after the laundry treatment, the laundry agent again deposits the clothes in the housing box so that the corresponding resident can receive the clothes subjected to the laundry treatment at a convenient time for his or her.

Some of the above-mentioned home delivery lockers or systems including the lockers are provided with a function for managing the usage situation of each housing box of the home delivery lockers.

By managing the usage situation of each housing box in this manner, the user such as a resident or the like can be utilize the home delivery locker efficiently, while confirming the usage situation.

As one of the prior art for managing the usage situation of the housing box of the above-mentioned housing device, Patent Document 1 has disclosed a lockable control device and a computer program thereof.

In Patent Document 1, a center server is provided with a locker information data base in which the usage situation, such as “in-use” or “empty”, or the like is stored, and referring to the usage situation of the locker in this locker information data base, the user can easily select a suitable empty locker from a plurality of lockers and utilizes the locker.

### Patent Document

[Patent Document] JP-A No. 2004-11397

### SUMMARY

### Problems to be Solved

However, in the delivery service for a home delivery object or the like, it is not until the user, that is, the receiver, as well as the delivery agent for the delivery confirm the usage situation of the locker that the delivery service is provided smoothly; however, in the invention disclosed in the above-mentioned Patent Document 1, since no information about the locker is given on the delivery agent, there might be a failure in smoothly providing the delivery service, for example, the delivery business is delayed because the position of an empty locker cannot be confirmed appropriately.

In view of the above-mentioned problems, the present invention has been devised, and its object is to provide a housing information providing system, which is used for a delivery service for a delivery object, and allows a delivery person for delivering the delivery object to easily confirm information of the housing device, thereby supporting the delivery business so as to be smoothly carried out.

### Means for Solving Problems

In order to achieve the above-mentioned object, the present invention relates to a housing information providing system having a housing device that is provided with one or more housing boxes and temporarily receives delivery objects by housing them in the housing boxes, and a management server for managing information in the housing boxes and a delivery person terminal that delivers delivery objects, and the managing server is characterized by transmitting information about the housing situation and reservation situation of the housing boxes of the housing device to the delivery person terminal.

Moreover, in accordance with the housing information providing system of the present invention, upon receipt of information for requesting reservation of a housing box of the housing device from the delivery person terminal, the managing server carries out the reservation process of the housing box whose reservation is requested, and in the case of unused state of the housing box, locks the housing box so as to inhibit the storing of a delivery object.

Furthermore, in accordance with the housing information providing system of the present invention, upon receipt of information for requesting reservation of a housing box of the housing device from the housing device, the managing server carries out the reservation process of the housing box whose reservation is requested, and in the case of unused state of the housing box, locks the housing box so as to inhibit the storing of a delivery object.

Furthermore, in accordance with the housing information providing system of the present invention, after passage of a predetermined period of time from the reservation process, the managing server cancels the reservation process of the housing box relating to the reservation process so as to unlock the housing box.

Furthermore, in accordance with the housing information providing system in the present invention, upon receipt of information for requesting reservation of a housing box of the housing device from the delivery person terminal, the managing server carries out the reservation process of the housing box whose reservation is requested, and in the case of used state of the housing box, when the housing box is brought into the unused state, it transmits information indicating the unused state of the housing box to the delivery person terminal.

Moreover, in accordance with the housing information providing system of the present invention, upon receipt of information for requesting reservation of a housing box of the housing device from the housing device, the managing server carries out the reservation process of the housing box whose reservation is requested, and in the case of used state of the housing box, when the housing box is brought into the unused state, it transmits information indicating the unused state of the housing box to the delivery person terminal.

Furthermore, in accordance with the housing information providing system of the present invention, after the passage of a predetermined period of time from the time when the housing box whose reservation process is carried out during its used state is brought into the unused state, it releases the reservation process of the housing box subjected to the reservation process so as to unlock the housing box.

Additionally, desired combinations of the above-mentioned constituent elements and those formed by mutually substituting the constituent elements and expressions of the present invention with methods, devices, systems, computer programs, recording media storing the computer programs are also effectively used as modes of the present invention

### Advantageous Effects

Since the housing information providing system of the present invention is provided with a housing device that includes one or more housing boxes and temporarily receives delivery objects by housing them in the housing boxes, and a management server for managing information in the housing devices and a delivery person terminal that delivers delivery objects, and since the managing server is characterized by transmitting information about the housing situation and reservation situation of the housing boxes of the housing device to the delivery person terminal, the delivery person for delivering the delivery object is allowed to easily confirm information of the housing device and consequently to smoothly carry out the delivery business in the delivery service of delivery objects.

### BRIEF DESCRIPTION OF DRAWINGS

FIG. 1 is a drawing that shows a configuration of a housing information providing system in accordance with a first embodiment of the present invention.

FIG. 2 is a drawing that shows a configuration of a housing device in the first embodiment of the present invention.

FIG. 3 is a drawing that shows an appearance on a front side of the housing device in the first embodiment of the present invention.

FIG. 4 is a drawing that shows a configuration of a managing server in the first embodiment of the present invention.

FIG. 5 is a drawing that shows each of data bases in which an information storing part of the managing server in the first embodiment of the present invention stores data.

FIG. 6 is a drawing that shows one example of a data configuration of a user DB in the first embodiment of the present invention.

FIG. 7 is a drawing that shows one example of a data configuration of a delivery person DB in the first embodiment of the present invention.

FIG. 8 is a drawing that shows one example of a data configuration of a housing device DB in the first embodiment of the present invention.

FIG. 9 is a drawing that shows one example of a data configuration of a loading history DB in the first embodiment of the present invention.

FIG. 10 is a drawing that shows one example of a data configuration of a housing box DB in the first embodiment of the present invention.

FIG. 11 is a drawing that shows a configuration of a delivery person terminal in the first embodiment of the present invention.

FIG. 12 is a sequence chart showing a flow of operations by the housing device at the time when a delivery person such as a delivery agent stores a delivery object in the housing device in the first embodiment of the present invention.

FIG. 13 is a drawing that shows one example of a starting screen displayed by the housing device in the first embodiment of the present invention.

FIG. 14 is a drawing that shows one example of an input screen for a delivery person ID displayed by the housing device in the first embodiment of the present invention.

FIG. 15 is a drawing that shows one example of an input screen for an exclusively owned-part information displayed by the housing device in the first embodiment of the present invention.

FIG. 16 is a drawing that shows one example of box screen information displayed by the housing device in the first embodiment of the present invention.

FIG. 17 is a flow chart that shows a flow of operations in the housing device at the time when the user takes a delivery object out of the housing device in the first embodiment of the present invention.

FIG. 18 is a sequence chart showing a flow of reservation operations of a housing box by using the delivery person terminal in the first embodiment of the present invention.

FIG. 19 is the sequence chart showing the flow of reservation operations of the housing box by using the delivery person terminal in the first embodiment of the present invention.

FIG. 20 is the sequence chart showing the flow of reservation operations of the housing box by using the delivery person terminal in the first embodiment of the present invention.

FIG. 21 is a drawing that shows one example of list information of the housing device in the first embodiment of the present invention.

FIG. 22 is a drawing that shows one example of a reservation box selection screen displayed by the delivery person terminal in the first embodiment of the present invention.

FIG. 23 is a sequence chart showing the flow of reservation operations of a housing box by using the housing device in the first embodiment of the present invention.

FIG. 24 is a sequence chart showing the flow of reservation operations of the housing box by using the housing device in the first embodiment of the present invention.

FIG. 25 is a drawing that shows a configuration of a housing part of the housing device in the first embodiment of the present invention.

### DETAILED DESCRIPTION

### First Embodiment

### (Outline of First Embodiment)

In a housing information providing system in accordance with a first embodiment of the present invention, by providing housing information including the current usage situation of a housing device for temporarily receiving and storing a delivery object to a delivery person, the delivery person can easily confirm in which timing the delivery object should be stored in the housing device or in which timing the delivery object should be collected therefrom.

Moreover, by utilizing the housing information providing system in the present embodiment, the delivery person can make a reservation of the housing box to be used from thereon.

### (Configuration of First Embodiment)

### (1) Entire Configuration of Housing Information Providing System

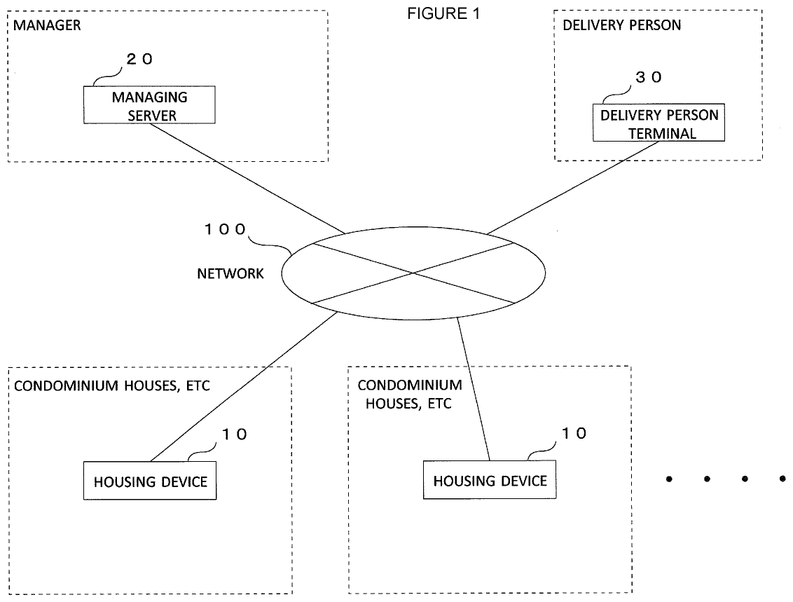

FIG. 1 is a drawing that shows a configuration of a housing information providing system in accordance with a first embodiment of the present invention. Referring to the drawing, explanation will be given on the configuration of the housing information providing system hereinbelow.

The housing information providing system is provided with a housing device 10 that is capable of housing a delivery object in a housing box, a managing server 20 that manages housing information including the usage situation of housing boxes of the housing device 10 and a delivery person terminal 30 that is operated by the delivery person who actually carries out the delivery business on the delivery object.

These apparatuses 10, 20 and 30 are mutually communicatably connected with one another through a network 100 such as the Internet, LAN or the like.

### (2) Configuration of Housing Device 10

### (2-a) Entire Configuration of Housing Device 10

The housing device 10 is installed in a residential/usage facility, and has a plurality of lockable housing boxes so that delivery objects are housed in the housing boxes.

For example, the housing device 10 may be a so-called home delivery locker that is installed in condominium houses, offices or the like, or may be a locker device that temporarily stores a delivery object, purchased commodities or the like in a post office, a supermarket or the like, or may be a coin locker installed in a public place, such as a station or the like, and a commercial facility, and this is not intended to be limited by those described above.

In the present embodiment, explanation will be given by exemplifying a home delivery locker that is installed in a commonly-used part (for example, entrance) or the like of condominium houses, as the housing device 10.

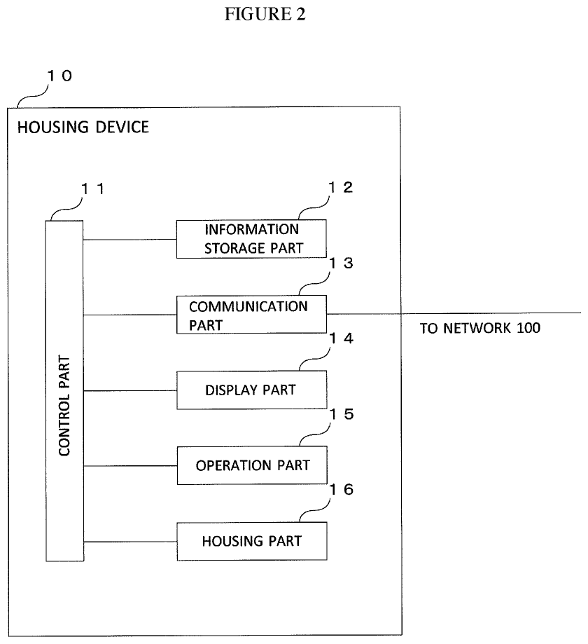

FIG. 2 is a drawing that shows a configuration of the housing device 10 in the first embodiment of the present invention.

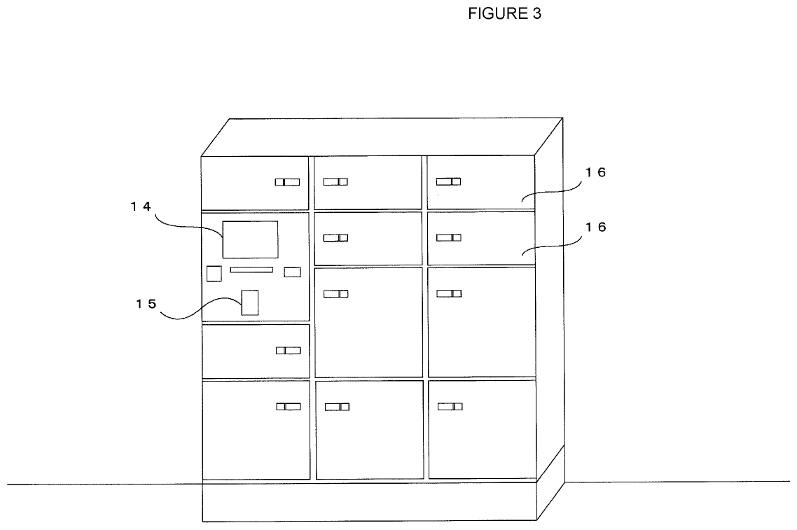

Moreover, FIG. 3 is a drawing that shows an appearance of the front side of the housing device 10 in the first embodiment of the present invention.

As shown in the drawings, the housing device 10 is provided with a control part 11 that controls the entire housing device 10 constituted by a CPU and the like, an information storage part 12 for storing various pieces of information, a communication part 13 for communicating with a managing server 20 through a network 100, a display part 14 for displaying various pieces of information, an operation part 15 that is provided with various keys so as to carry out information input, and also carries out reading processes or the like of identification information for unlocking the housing box, and a housing part 16 provided with a plurality of housing boxes for housing delivery objects.

The respective parts 11 to 16 are connected to an inner bus, and through this bus, various pieces of information or the like are inputted/outputted thereto/therefrom so that various processes are executed under control of the control part 11.

The control part 11, which is a processing part for controlling the entire housing device 10, includes, for example, electronic circuits, such as a CPU (Central Processing Unit) or the like and integrated circuits, such as FPGA (Field-Programmable Gate Array) or the like.

The control part 11 executes reading processes of information from the information storage part 12 and also executes writing processes of information on the information storage part 12.

The information storage part 12 is a device for storing information of a hard disc, a memory, a semiconductor element, or the like.

The information storage part 12 is provided with a region for storing programs to be executed in the control part 11 and a work region (RAM, etc.) or the like that is temporarily used when the control part 11 executes processes, and stores data bases and tables to be described later.

The control part 11 reads out a program stored in the information storage part 12 and develops it on the work region so as to execute various processes.

The information storage part 12 stores information of used states for the respective plural housing boxes of the housing part 16.

The control part 11 refers to the information of used state of the above-mentioned housing boxes, and detects “in-use” or “unused” of each of the housing boxes.

Moreover, the information storage part 12 stores identification information for use in unlocking the housing box for each of the housing boxes.

When identification information is inputted thereto by the operation part 15, the control part 11 collates the inputted identification information with identification information stored in the information storage part 12 so as to carry out identification.

When the identification is successful, the control part 11 unlocks the corresponding housing box.

On the other hand, when the identification is not successful, the control part 11 does not unlock the corresponding housing box and keeps it locked.

The communication part 13 corresponds to an interface for controlling communications with the managing server 20 through the network 100, and is provided with a LAN adopter or the like.

The communication part 13 may have a wireless transmitter/receiver, and may be connected to the LAN, Internet or the like through wireless communication, or may be connected thereto through a wire such as a cable or the like.

The display part 14 is a display device, such as a display, lamps or the like.

The control part 11 reads out an image from the information storage part 12, and generates screen information by executing an image output process thereon. Moreover the control part 11 allows the communication part 13 to execute an image output process on image information received from the managing server 20 so as to generate screen information.

The control part 11 outputs the generated image information onto the display part 14.

The display part 14 executes screen display of the inputted image information on a display or the like.

Moreover, the control part 11 may output a control signal onto the display part 14 so that lamps possessed by the display part 14 may be turned on.

The operation part 15 is provided with an information input device constituted by, for example, various keys or the like, and the information input device provides a pointing device in cooperation with the display part 14. The operation part 15 receives various operations by a user or the like, and outputs a signal indicating the operation contents to the control part 11 or the like.

Upon receipt of the signal indicating the operation contents, the control part 11 outputs a control signal indicating that a screen display in response to the operation contents is carried out to the display part 14 in accordance with the contents of the signal.

Upon receipt of the control signal input, the display part 14 executes a screen display in response to the control signal.

Additionally, the display part 14 and the operation part 15 may be integrally constituted to form a touch panel.

Moreover, the operation part 15 is provided with an information reading device that reads out information from an information recording medium (identification medium to be described later) such as IC cards, magnetic recording cards, or the like, by carrying out short-distance wireless communication, such as infrared ray communication or the like.

After reading the identification information or the like from the identification medium by the operation part 15, the control part 11 carries out an identifying process for unlocking the housing part 16 based upon the identification information or the like thus read out.

When the user brings the identification medium in which identification information for unlocking the key is recorded closer within a predetermined distance by holding it over the operation part 15 (information reading device), the operation part 15 reads out the identification information for unlocking the key from the identification medium.

### (2-b) Configuration of Housing Part 16 of Housing Device 10

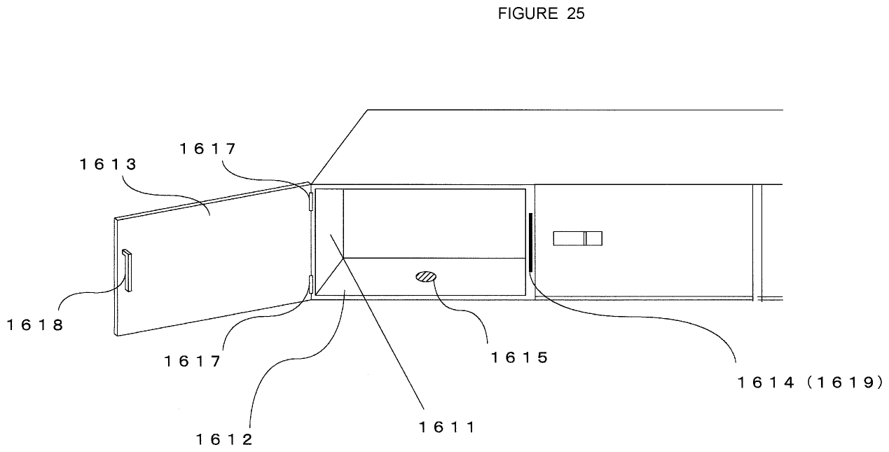

FIG. 25 is a drawing that shows a configuration of the housing part 16 of the housing device 10 in the first embodiment of the present invention.

The housing part 16 is constituted by a plurality of housing boxes.

Each of the housing boxes is a housing locker for temporarily storing a delivery object, a postal matter or the like addressed to a user, and is lockably/unlockably designed.

For example, even in the case when the user is not at home, the delivery person stores the delivery object or the like addressed to the user in the housing box and locks it so that the housing part 16 can safely maintain the delivery object or the like until the user comes to take out it.

In the case when no article is housed in the housing box, no identification for unlocking and opening the door is required, and by using an operation (key inputting operation or the like) of the operation part 15, unlocking and door opening can be made.

Moreover, in the housing box, an article detection part 1615 for detecting the fact that any article is housed is installed, and the article detection part 1615 is designed to be connected to the control part 11.

In this case, based upon the input signal from the article detection part 1615, the control part 11 can confirm (detect) that any article is housed in the housing box.

The above-mentioned article detection part 1615 is constituted by, for example, an optical sensor, such as an infrared-ray sensor or the like, a weight sensor and like.

As shown in FIG. 25, the housing box is provided with a housing chamber 1611 serving as a housing space for a delivery object or the like addressed to a user, a loading/unloading opening 1612 that is a loading/unloading opening for a delivery object or the like, a door 1613 serving as an opening/closing member that closes the above-mentioned loading/unloading opening 1612 at the time of locking, a locking/unlocking part 1614 that is constituted by an electronic lock or the like, and locks the above-mentioned door 1613, with the loading/unloading opening 1612 being closed, and also unlocks the lock when an unlocking signal is inputted thereto from the control part 11, an article detection part 1615 that detects a housing state of an article inside the housing chamber 1611, a hinge part 1617 that connects the housing chamber 1611 and the door 1613 with each other, and a hook 1618 attached to the rear side of the door 1613.

The housing chamber 1611 has a box body having a rectangular parallelepiped shape, with at least one of the faces being opened.

The housing chamber 1611 and the door 1613 are made of, for example, iron and another metal or alloy, and have such strength as not to be easily broken from the outside at the time of being closed.

Each of the doors 1613 is attached to the housing chamber 1611 so as to be freely rotatable through the hinge part 1617.

Moreover, each hook 1618 is attached to the rear side of the door 1613.

Onto the door 1613 of the housing box, an urging force is exerted in the opening direction so that when unlocked by the locking/unlocking part 1614, the door 1613 is automatically opened.

Moreover, when a user stores an article into the housing box so as to be locked, for example, by allowing the user to close the door 1613 against the above-mentioned urging force, the locking process is automatically carried out.

The locking/unlocking part 1614 is provided with a general electronic lock, mechanical lock or the like, and its type is not particularly limited.

In the present embodiment, for example, explanation will be given below by exemplifying that the locking/unlocking part has an electronic lock.

At the time of locking, the locking/unlocking part 1614 fixes the door of the housing chamber while the loading/unloading opening thereof is closed so as to suppress the door from opening. In this case, neither an article housed in the housing box can be taken out from the outside, nor an article can be housed in the housing box.

The locking/unlocking part 1614 is provided with a hook hole 1619 to which the above-mentioned hook 1618 is inserted at the time of closing the door, on the opening surface of the housing chamber 1611.

Moreover, the locking/unlocking part 1614 is provided with an opening/closing door detection part 1619c that is a sensor for sensing the opening/closing of the door 1613 at the depth of the hook hole 1619.

The opening/closing door detection part 1619c has, for example, a switch-shaped member, and when the hook 1618 is inserted to the hook hole 1619, the tip of the inserted hook 1618 is allowed to press the switch-shaped member of the opening/closing door detection part 1619c so that the opening/closing door detection part 1619c can detect that the door 1613 is closed.

Furthermore, the locking/unlocking part 1614 is provided with a stopping part that stops the inserted hook 1618 inside the hook hole 1619 so as to regulate the movement thereof.

For example, materials for the hook 1618 and stopping part are metal; however, the materials are not intended to be limited by this.

For example, the stopping member for stopping the above-mentioned hook 1618 in the stopping part is formed by a lever or the like made of metal, and by operating the lever so as to be made in contact with the hook 1618, the hook 1618 is stopped so as to suppress the door from opening.

The locking/unlocking part 1614 is communicatably connected to the control part 11 through a communication cable or the like.

When an unlocking request signal for requesting the unlocking of a housing box is inputted thereto and the unlocking request is permitted, the control part 11 outputs an unlocking signal to the locking/unlocking part 1614 of the corresponding housing box.

Upon receipt of the unlocking signal, the locking/unlocking part 1614 operates the lever of the stopping part or the like so as to release the stopped state, thereby unlocking the housing box.

When locked, the locking/unlocking part 1614 detects the locked state, and transmits a locking detection signal to the control part 11. Moreover, the locking/unlocking part 1614 (opening/closing door detection part 1619c) detects an opened door state or closed door state of the door 1613, and transmits an opened door detection signal or a closed door detection signal indicating the opened or closed state of the door thus detected to the control part 11.

First, explanation will be given on operations at the time of locking the housing box.

When the door 1613 is closed and the loading/unloading opening 1612 is closed, the hook 1618 attached to the rear surface of the door 1613 is inserted into the hook hole 1619 of the locking/unlocking part 1614 installed on the housing chamber 1611 so that the tip of the hook 1618 is pressed onto the opening/closing door detection part 1619c installed at the depth of the hook hole 1619, the opening/closing door detection part 1619c detects that the door 1613 is closed.

In this case, upon detection of the closed door, the opening/closing door detection part 1619c may physically move members made of metals or the like, such as levers, cams and the like, possessed by itself, and by using these as a trigger, the locking/unlocking part 1614 may output the closed door detection signal to the control part 11.

Upon detection of the closed door state of the door 1613 by the opening/closing door detection part 1619c, the locking/unlocking part 1614 operates the stopping part possessed by itself so as to stop the hook 1618 inserted into the hook hole 1619 to be fixed therein, thereby carrying out a locking process by suppressing the door from opening.

Next, explanation will be given on operations at the time of unlocking the housing box.

When an unlocking of a housing box is requested and the unlocking request is permitted, the control part 11 generates an unlocking signal and outputs this to the locking/unlocking part 1614.

Upon receipt of the unlocking signal from the control part 11, the locking/unlocking part 1614 moves the stopping member of the stopping part so that the stopped state of the stopped hook 1618 is released so as to carry out an unlocking operation.

When the stopped state by the stopping part of the hook 1618 is released, the door 1613 can be freely opened.

On principle, each of the housing boxes is locked in any of cases of a housed state or an unhoused state of a delivery object.

Once a delivery object is housed therein, the locking and door closing operations are carried out so that the delivery object is safely stored until the addressed user comes to take it out. In the case when the delivery object is housed, identification of the addressed user of the delivery object is carried out and if the identification is successful, the unlocking operation is carried out.

The article detection part 1615 is a sensor for detecting the fact that any article is housed in the housing chamber 1611.

The article detection part 1615 is communicatably connected to the control part 11 through a communication cable or the like.

Upon detection that any article is housed therein, the article detection part 1615 transmits an article detection signal to the control part 11.

Upon receipt of the above-mentioned article detection signal and locking detection signal, as well as moreover, a door opening/closing detection signal, the control part 11 writes the status of the usage situation of the corresponding housing box onto the information storage part 12, based upon the respective detection signals.

For example, the article detection part 1615 is a general infrared-ray sensor provided with a light projector and a light receiver. In this case, the light projector applies an infrared ray into the housing chamber 1611, and the light receiver receives the ray. In the case when an article is located in the housing chamber 1611, the infrared ray applied from the light projector is interrupted so that no ray is received by the light receiver. In this case, the article detection part 1615 can detect the article inside the housing chamber 1611.

Moreover, in the case when the light receiver is such a type as to receive reflected light of the infrared ray applied from the light projector, if there is any article inside the housing chamber 1611, the infrared ray is reflected from an article surface and the resulting light is received by the receiver so that the presence of the article can be detected.

In another example, the article detection part 1615 is provided with, for example, a weight meter.

In the case when the article detection part 1615 is the type provided with this weight meter, the weight meter is installed on the bottom surface of the housing chamber 1611, and when any article is housed inside the housing chamber 1611, the weight meter detects the weight of the article. Thus, the article detection part 1615 detects the existence of the article inside the housing chamber 1611.

As described above, the housing box of the housing part 16 is provided with an opening part through which a delivery object can be housed or taken out therefrom, and the opening part is designed to be shield by a door and locked by the door.

When each of the housing boxes is housed with a delivery object, its door is closed and locked so as to safely store the delivery object, and the unlocking and door opening processes are carried out by inputting identification information onto the operation part 15.

On the other hand, in the case when no delivery object is housed in each of the housing boxes, the locked or unlocked state is made, and of these, in the case of the locked state, the door can be unlocked by using a predetermined operation (key input or the like) on the operation part 15, without the necessity of inputting identification information.

Moreover, reservation is made on one of the housing boxes, the corresponding housing box is locked, and even when a delivery object is unhoused, only the person who has made the reservation or a person belonging to a group of the person (with respect to the group, explanation will be given later) can unlock the corresponding housing box.

Inside of each of the housing boxes, a delivery object detection sensor for detecting the fact that a delivery object is housed therein is installed, and the corresponding delivery object detection sensor may be connected to the control part 11.

In this case, based upon an input signal from the corresponding delivery object detection sensor, the control part 11 can confirm (detect) that a delivery object is housed in each of the housing boxes.

The above-mentioned delivery object detection sensor is constituted by, for example, an optical sensor such as an infrared ray sensor, a weight sensor or the like.

### (3) Configuration of Managing Server 20

The managing server 20 is an information processing device for managing user information and the housing situation of a delivery object addressed to a user in the housing device 10, and may be installed on inside or outside of a residential/usage facility.

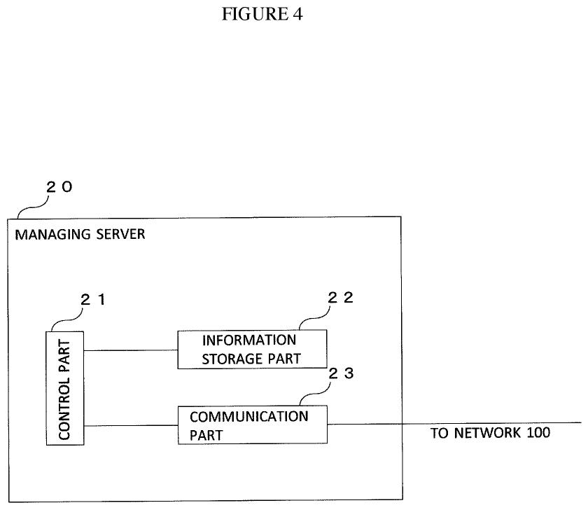

FIG. 4 is a drawing that shows a configuration of a managing server 20 in the first embodiment of the present invention.

As shown in the drawing, the managing server 20 is provided with a control part 21 that controls the entire managing server 20, an information storage part 22 for storing pieces of information, such as user information and the situation and the like of a delivery object, and a communication part 23 for transmitting and receiving various pieces of information between the housing device 10 and the delivery person terminal 30.

The respective parts 21 to 23 are connected to an inner bus, and through this bus, various pieces of information or the like are inputted/outputted thereto/therefrom so that various processes are executed under control of the control part 21.

The control part 21, which is a processing part for controlling the entire managing server 20, includes, for example, electronic circuits, such as a CPU (Central Processing Unit) or the like and integrated circuits, such as FPGA (Field-Programmable Gate Array) or the like.

The control part 21 executes reading processes of information from the information storage part 22 and also executes writing processes of information on the information storage part 22.

The information storage part 22 is a device for storing information of a hard disc, a memory, a semiconductor element, or the like.

The information storage part 22 is provided with a region for storing programs to be executed in the control part 21 and a work region (RAM, etc.) or the like that is temporarily used when the control part 21 executes processes, and stores data bases to be described later.

The control part 21 reads out a program stored in the information storage part 22 and develops it on the work region so as to execute various processes.

The communication part 23 corresponds to an interface for controlling communications between the housing device 10 and the delivery person terminal 30 carried out through the network 100, and is provided with a LAN adopter or the like.

The communication part 23 may have a wireless transmitter/receiver, and may be connected to the LAN, Internet or the like through wireless communication, or may be connected thereto through a wire such as a cable or the like.

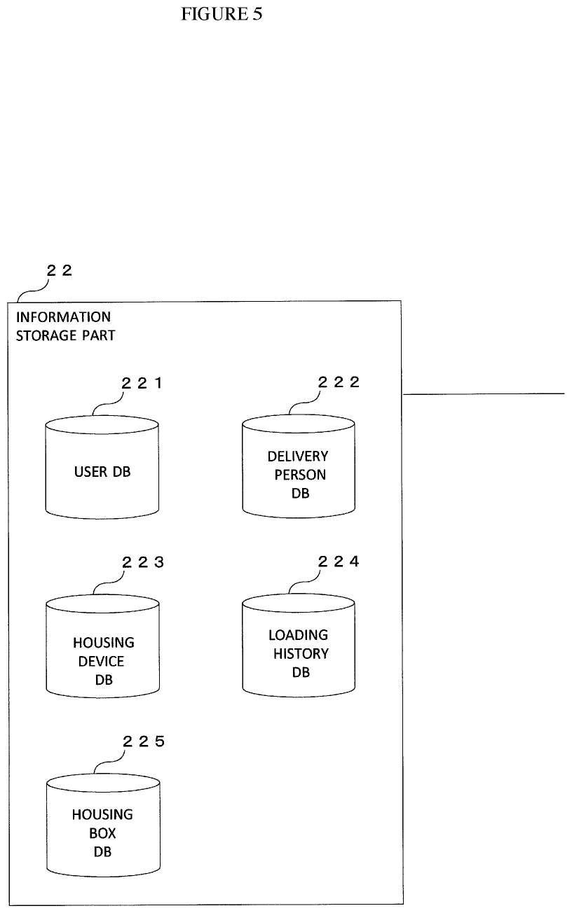

FIG. 5 is a drawing that shows respective data bases 221 to 225 used for storing data by the information storage part 22 of the managing server 20 in accordance with the first embodiment of the present invention.

As shown in the drawing, the information storage part 22 stores a user DB 221 for managing personal information of users serving as delivery ends of delivery objects, a delivery person DB 222 for managing information of the delivery person for carrying out deliveries of delivery objects, a housing device DB 223 for managing installation places of the housing devices 10, a loading history DB 224 for managing the loading history of delivery objects to the respective housing devices 10, and a housing box DB 225 for managing the housing situation or the like of the respective housing boxes.

When the managing server 20 receives identification information or the like from the housing device 10, the control part 21 collates the received identification information with identification information managed by the user DB 221 so as to carry out an identification process. As a result of the identification, in the case of a failure, the locked state of the housing box in which a delivery object is housed, as it is, is maintained, while in the case of a success, the housing box in which the delivery object is housed is unlocked so that the user is allowed to take out the delivery object from the inside of the housing box.

Moreover, when the managing server 20 receives a delivery person ID for identifying the delivery person from the housing device 10, the control part 21 collates the received delivery person ID with information about the reservation of the housing box registered in the housing box DB 225 so as to carry out an identification process. As a result of the identification, in the case of a failure, the locked state of the housing box that has been reserved is maintained, as it is, while in the case of a success, the housing box that has been reserved is unlocked so that the delivery person is allowed to load a delivery object in the housing box.

The user DB 221 is a data base for managing information relating to users (residents or the like of condominium houses) corresponding to receivers (addresses) of delivery objects.

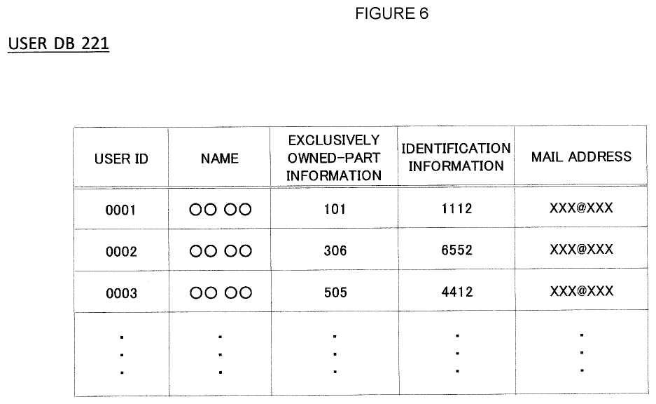

FIG. 6 is a drawing that shows one example of a data configuration of the user DB 221 in the first embodiment of the present invention.

In the example shown in the drawing, the user DB 221 manages user names, user's exclusively owned-part information (room number), identification information for unlocking the housing box and mail addresses in association with ID's (user ID) identifying the respective users.

The exclusively owned-part information refers to information for use in identifying each exclusively owned-part in condominium houses or the like, and for example, includes a room number of each house.

In the present embodiment, identification information is set to each of the exclusively owned-parts, and the corresponding identification information is managed in the user DB 221 as described above. That is, in the present embodiment, for example, to users who live in the same exclusively owned-part or utilize the part, the same identification information is assigned, and they are managed by the user DB 221.

Moreover, in the example of the drawing, the user DB 221 manages mail addresses as information of contact address (user terminal or the like) of the user; however, not intended to be limited by this, any information may be used as long as it is information of contact address.

In each of the housing boxes, only in the case when a delivery object that is addressed to the user, himself or herself, or another user who lives in or utilizes the same exclusively owned-part as the user is housed, the user can unlock the box by using identification information of himself or herself, and with respect to the housing box in which a delivery object addressed to a person other than the user or the other user is loaded, the box cannot be unlocked.

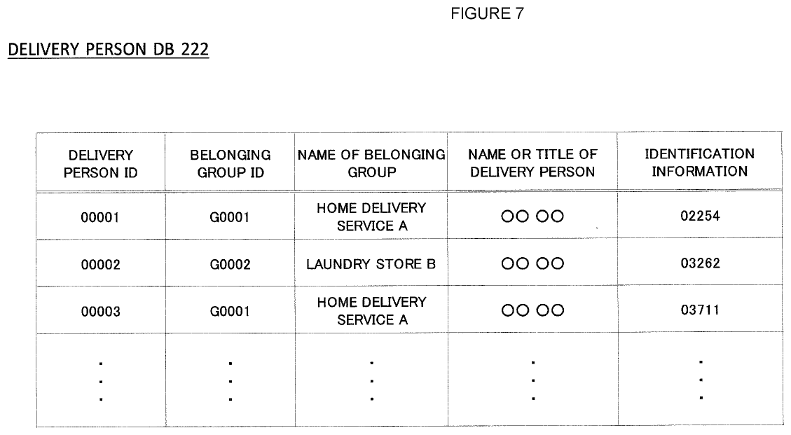

FIG. 7 is a drawing that shows one example of data configuration of the delivery person DB 222 in the first embodiment of the present invention.

The delivery person DB 222 shown in the drawing manages a group ID of a group (enterprise, store or the like) to which the delivery person belongs, the name of the group to which he or she belongs, and the name or the title of the delivery person, in association with the delivery person ID for identifying each delivery person.

When a delivery person starts reservation of a housing box by inputting the delivery person ID by using the delivery person terminal 30 or the housing device 10, the housing device 10 transmits the corresponding delivery person ID to the managing server 20. When the managing server 20 receives the delivery person ID, the control part 21 of the managing server 20 refers to the delivery person DB 222, and extracts the group ID in association with the delivery person ID thus received, and then registers the extracted group ID or the delivery person ID in the housing box DB 225 as an unlocking permitted person having an unlocking authenticity of the reserved housing box so as to carry out reservation.

The housing device DB 223 is a data base for managing installation places of one or more housing devices 10.

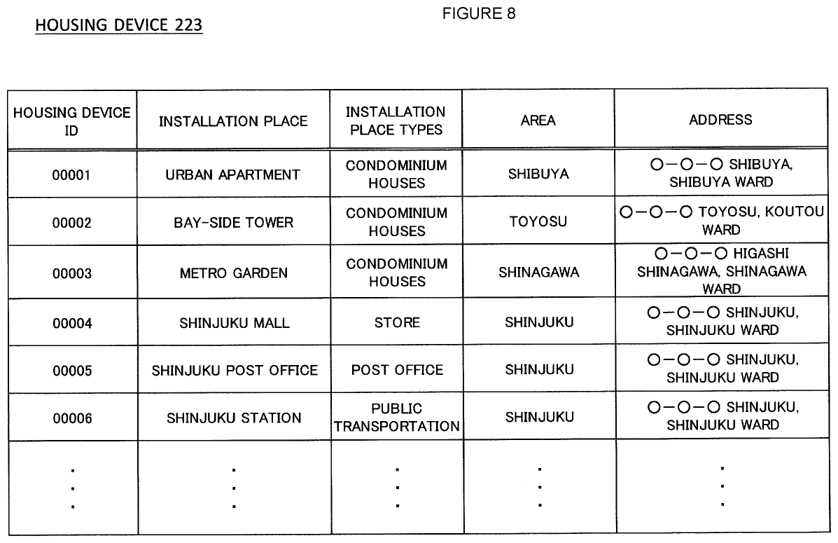

FIG. 8 is a drawing that shows one example of a data configuration of the housing device DB 223 in the first embodiment of the present invention.

The housing device DB 223 shown in the drawing manages the installation places of the respective housing devices 10, the types of the installation places (stores, facilities, condominium houses, etc.), roughly determined areas of the installation places and the addresses of the installation places, in association with the housing device ID for identifying each of the housing devices 10.

The loading history DB 224 is a data base for managing the loading history of a delivery object for each of the housing devices 10.

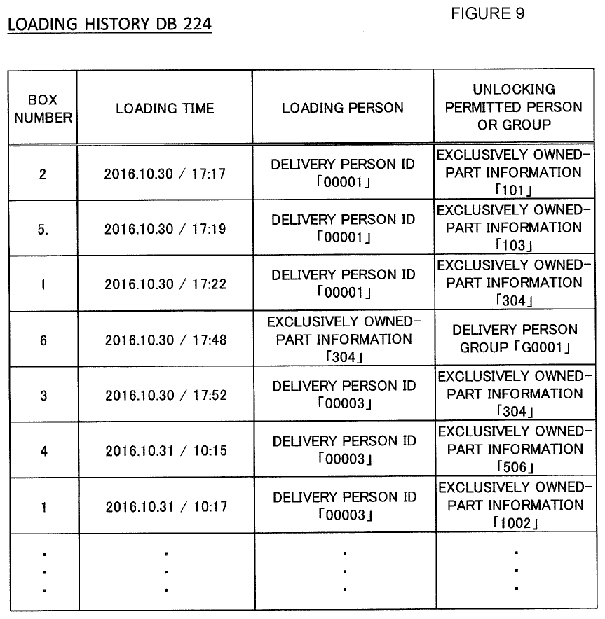

FIG. 9 is a drawing that shows one example of a data configuration of the loading history DB 224 in the first embodiment of the present invention.

The loading history DB 224 shown in the drawing manages a box number of a housing box to which a delivery object is loaded, its loading time, its loading person (delivery person or user) and a person (delivery person, user or the like) who is currently permitted to unlock the box or an unlocking permitted person (delivery person or user) indicating a group (enterprise, another organization or the like).

The housing box DB 225 is a data base for managing reservation information or the like of a housing box for each of the housing devices 10, in addition to the loading history recorded on the loading history DB 224.

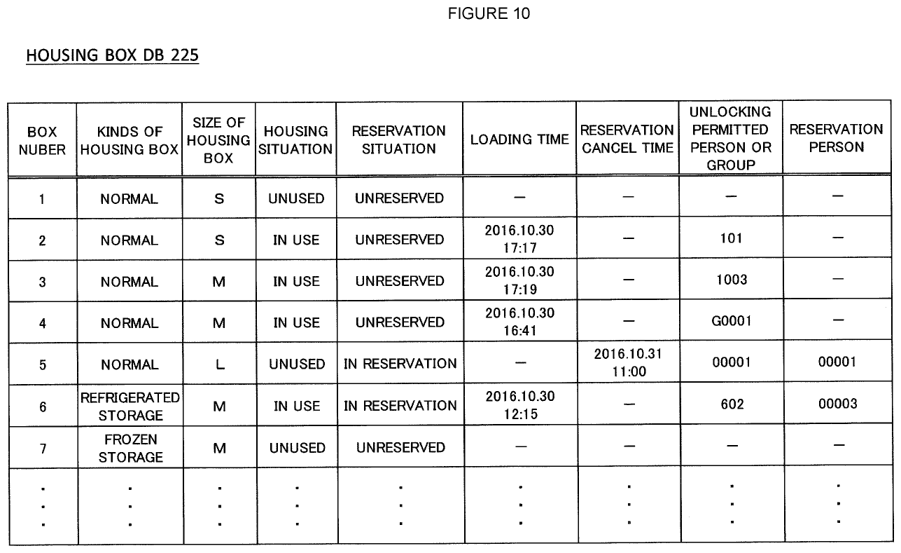

FIG. 10 is a drawing that shows one example of a data configuration of the housing box DB 225 in the first embodiment of the present invention.

In each of the housing boxes, the housing box DB 225 shown in the drawing manages the types of the housing boxes, the sizes of the housing boxes, the housing situation (in-use or unused), the reservation situation (in reservation or unreserved), the loading time of the delivery object, the reservation cancel time indicating the time at which the current reservation is automatically canceled, the unlocking permitted person indicating a currently unlocking permitted person (delivery person, user or the like) or group (enterprise or other organizations or the like) and the reserving person indicating a person who is making reservation of a housing box.

The control part 21 registers an ID for identifying the person and group corresponding to the unlocking permitted person (delivery person ID, group ID or the like) in the column of the above-mentioned unlocking permitted person.

The above-mentioned group ID is an ID for use in identifying a group to which the delivery person belongs, and in the case when unlocking of a reserved housing box is permitted in a group unit, all the delivery persons belonging to the corresponding group can unlock the corresponding housing box.

The group identified by the corresponding group ID refers to a group to which the delivery persons belong, such as, for example, a store, an enterprise, a department, an organization, a public organization or the like. More specific examples of the above-mentioned groups include delivery companies, such as home delivery service, post offices, or the like, laundry stores, supermarkets for carrying out food delivery business, or the like.

In the example of the drawing, in the housing box DB 225, a housing box having a box number “2” normally corresponds to an S-size housing box in which a delivery object addressed to a user of “room number: 101” is deposited at “pm 17:17 on Oct. 30, 2016”.

Moreover, for example, in the housing box DB 225, a housing box having a box number “5” normally corresponds to an L-size housing box whose reservation is made by a delivery person having a delivery person ID “00001”, and unlocking thereof is permitted to the corresponding delivery person.

In the case when the corresponding delivery person who is the unlocking permitted person has not unlocked the corresponding housing box so as to load a delivery object until reservation cancel time “am 11:00 on Oct. 31, 2016”, the control part 21 forcefully cancel the corresponding reservation.

### (4) Configuration of Delivery Person Terminal 30

The delivery person terminal 30 is an information processing device operated by a delivery person who delivers a delivery object to the addressed user.

For example, the delivery person terminal 30 is a portable information processing device, such as a smartphone, a tablet terminal, a wareable terminal, a mobile telephone, PDA, PHS, PC or the like.

The delivery person terminal 30 receives housing information for a housing box of the housing device 10 from the managing server 20, and carries out a display, a voice output, or the like.

In this case, the housing information refers to information indicating the usage situation, reservation situation or the like of each of the housing boxes managed in the housing box DB 225.

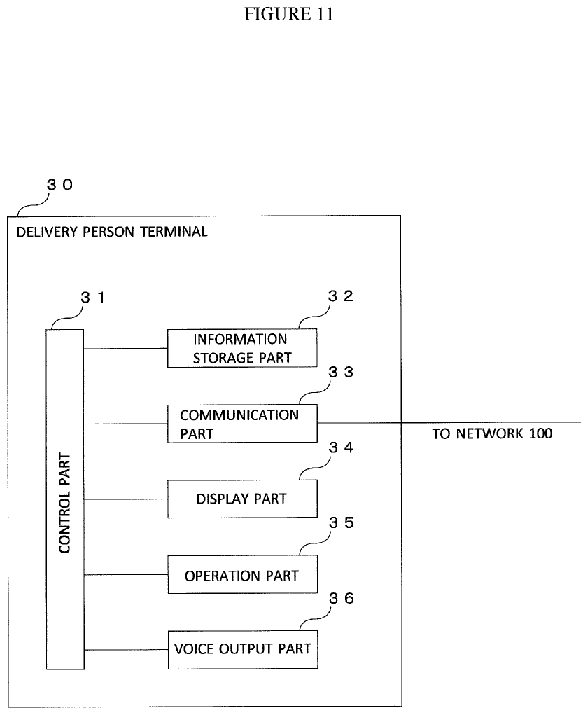

FIG. 11 is a drawing that shows a configuration of the delivery person terminal 30 in the first embodiment of the present invention.

As shown in the drawing, the delivery person terminal 30 is constituted by a control part 31 that is composed of a CPU or the like so as to control the entire delivery person terminal 30, an information storage part 32 for storing various pieces of information, such as a delivery person ID or the like of the delivery person for operating the delivery person terminal 30 and a communication part 33 for transmitting/receiving information to/from the managing server 20 through the network 100, such as the Internet or the like, a display part 34 for displaying various kinds of information, an operation part 35 constituted by various kinds of keys, buttons and like, for inputting various kinds of information, and a voice output part 36 constituted by a speaker or the like for outputting voice.

Moreover, the above-mentioned display part 34 and the operation part 35 may be integrally constituted to form a touch panel.

The respective parts 31 to 36 are connected to an inner bus, and through the bus, various pieces of information or the like are inputted/outputted so that under the control of the control part 31, various processes are executed.

By transmitting/receiving information to/from the managing server 20 and by displaying the information received from the managing server 20, the delivery person terminal 30 allows the delivery person to confirm the housing situation of the housing boxes of the housing device 10 and to make reservation of the housing box, and the control part 31 carries out these processes by executing applications (software) installed (packaged) in the information storage part 32.

The corresponding applications may be installed, for example, through a storage medium, or may be downloaded and installed through the network.

The control part 31, which is a processing part for controlling the entire user terminal 30, is constituted by, for example, electronic circuits, such as a CPU (Central Processing Unit) or the like and integrated circuits, such as FPGA (Field-Programmable Gate Array) or the like.

The control part 31 executes reading processes of information from the information storage part 32 and also executes writing processes of information on the information storage part 32.

The information storage part 32 is a device for storing information of, for example, a hard disc, a memory, a semiconductor element, or the like.

The information storage part 32 is provided with a region for storing programs to be executed in the control part 31 and a work region (RAM, etc.) or the like that is temporarily used when the control part 31 executes processes, and stores data bases and tables to be described later.

The control part 31 reads out a program stored in the information storage part 32 and develops it on the work region so as to execute various processes.

The communication part 33 corresponds to an interface for controlling communications with the managing server 20 through the network 100, and is provided with a LAN adopter or the like.

The communication part 33 may have a wireless transmitter/receiver, and may be connected to the LAN, Internet or the like through wireless communication, or may be connected thereto through a wire such as a cable or the like.

The display part 34 is a display device, such as a display, lamps or the like.

The control part 31 reads out an image from the information storage part 32, and generates screen information by executing an image output process thereon. Moreover the control part 31 allows the communication part 33 to execute an image output process on image information received from the managing server 20 so as to generate screen information.

The control part 31 outputs the generated image information onto the display part 34.

The display part 34 executes screen display of the inputted image information on a display or the like.

Moreover, the control part 31 may output a control signal onto the display part 34 so that lamps possessed by the display part 34 may be turned on.

The operation part 35 is provided with an information input device constituted by, for example, various keys or the like, and the information input device provides a pointing device in cooperation with the display part 34. The operation part 35 receives various operations by a user or the like, and outputs a signal indicating the operation contents to the control part 31 or the like.

When the signal indicating the operation contents is inputted thereto, the control part 31 outputs a control signal indicating that a screen display corresponding to the operation contents is carried out to the display part 34 in accordance with the contents of the signal.

Upon receipt of the control signal, the display part 34 carries out a screen display corresponding to the control signal.

The voice output part 36 is provided with a voice output device such as, for example, a speaker or the like, and upon receipt of a control signal from the control part 31, carries out a predetermined voice output in accordance with the control signal.

### (Operation of First Embodiment)

(1) Operations at the Time when Delivery Person Loads Delivery Object

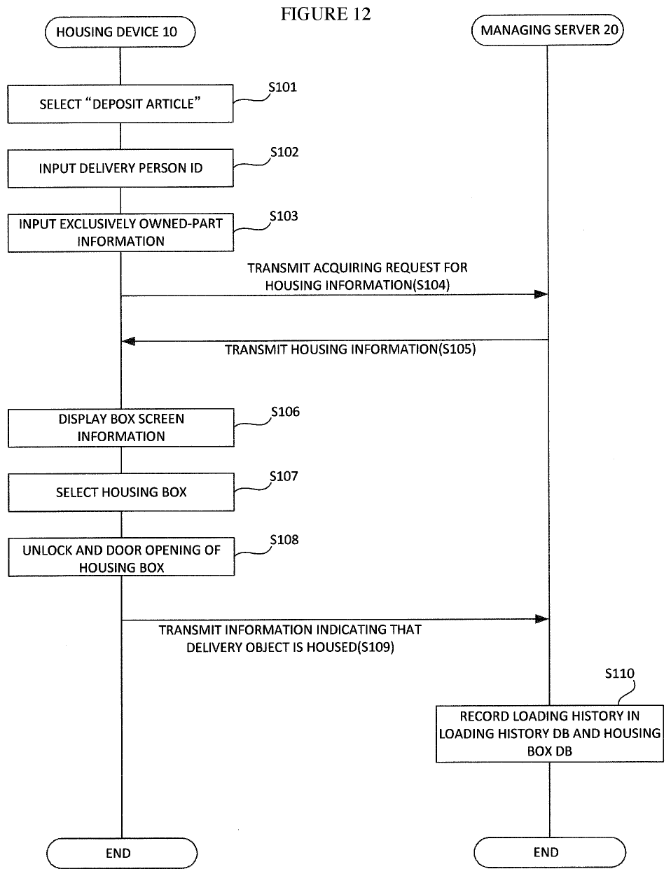

FIG. 12 is a sequence chart showing a flow of operations by the housing device 10 at the time when a delivery person such as a delivery agent stores a delivery object in the housing device 10 in accordance with the first embodiment of the present invention.

Referring to the present drawing, explanation will be given on operations by the housing device 10 at the time when a delivery person stores a delivery object addressed to a user in the housing box.

Additionally, in the present example, it is supposed that the delivery object to be housed by the delivery person is a delivery object or the like.

First, the delivery person carrying a delivery object addressed to a user visits at an installation place of the housing device 10 at the entrance or the like of condominium houses.

On the display part 14 of the housing device 10, a start screen for selecting a use object of the housing device 10 is displayed.

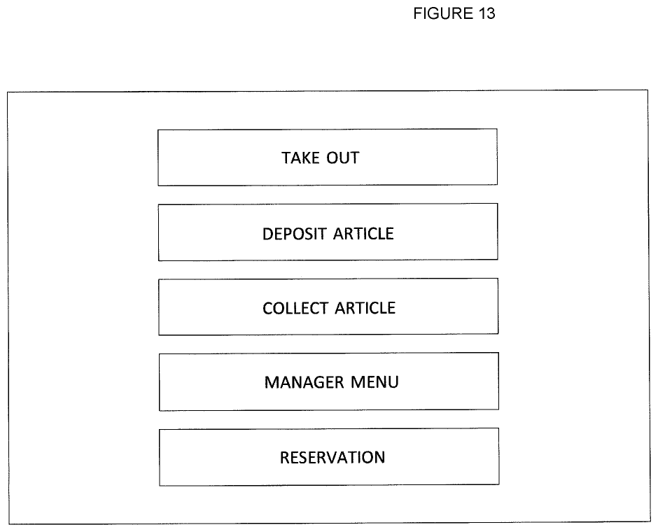

FIG. 13 is a drawing that shows one example of the start screen displayed by the housing device 10 in the first embodiment of the present invention.

In the example shown in the drawing, on the start screen, as use objects of the housing device 10, “Take out”, “Deposit of Article”, “Collect of Article”, “Administrator Menu” and “Reservation” are displayed.

By using the operation part 15 of the housing device 10, the delivery person selects the corresponding object in this case from a plurality of use objects on the start screen (step S101).

In this case, the delivery person selects “Deposit of Article”.

When “Deposit of Article” is selected as the use object of the housing device 10, the display part 14 displays an input screen for the delivery person ID.

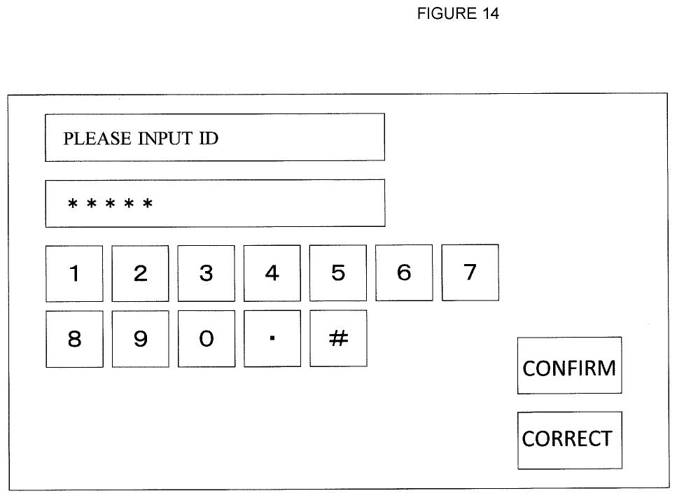

FIG. 14 is a drawing that shows one example of the input screen for the delivery person ID displayed by the housing device 10 in the first embodiment of the present invention.

In the example shown in the drawing, on the input screen for the delivery person ID, an input column for the delivery person ID of the delivery person who deposits a delivery object addressed to a user to the housing device 10 is installed.

In this case, by using the operation part 15, the delivery person inputs the delivery person ID of himself or herself in the input column on the input screen of the delivery person ID (step S102).

As described above, when the delivery person ID is inputted, the display part 14 displays an input screen of an exclusively owned-part information (room number) of a delivery end.

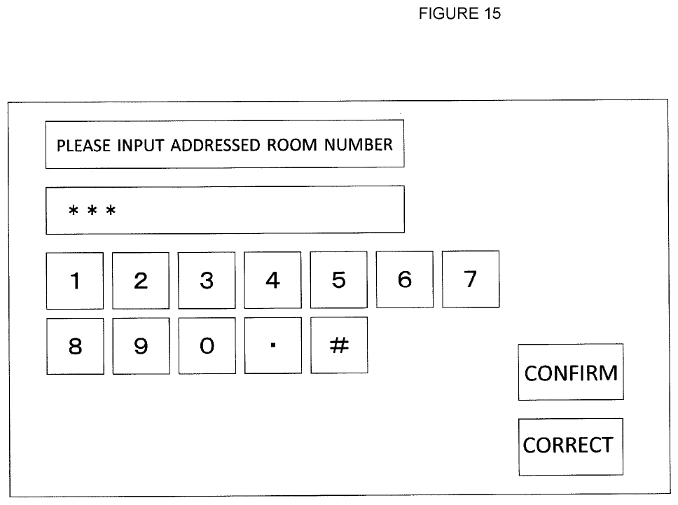

FIG. 15 is a drawing that shows one example of an input screen for an exclusively owned-part information displayed by the housing device 10 in the first embodiment of the present invention.

In the example shown in the drawing, on the input screen of exclusively owned-part information, an input column for use in inputting exclusively owned-part information of a delivery object addressed to a user to be deposited by the delivery person at this time is formed.

In this case, by using the input part 15, the delivery person inputs exclusively owned-part information (room number) in the above-mentioned input column (step S103).

When the exclusively owned-part information is inputted as described above, the control part 11 allows the communication part 13 of the housing device 10 to transmit a request for acquiring housing information of a housing box of its own device 10 to the managing server 20 (step S104).

When the managing server 20 receives the acquiring request of the housing information of the housing box of the above-mentioned housing device 10, the control part 21 extracts housing information from the housing box DB 225, and allows the communication part 23 to transmit the extracted housing information to the housing device 10 (step S105).

When the communication part 13 of the housing device 10 receives the housing information of the above-mentioned own device 10 from the managing server 20, the control part 11 displays box screen information divided in the following three kinds of (A) to (C) of the housing situations of the housing boxes of the own device 10 based upon the received housing information (step S106).

(A) Loadable Housing Boxes

(B) Housing Box in Reservation

(C) Unloadable Housing Boxes

Explanation will be given on the above-mentioned housing boxes (A) to (C) in detail as shown below.

“(A) Loadable Housing Boxes” refer to the housing box that is “unused” and “unreserved” in the current housing situation on the housing box DB 225, and any one including the currently operating delivery person can deposit a delivery object therein.

“(B) Housing Box in Reservation” refer to the housing box that is “unused” and “in reservation” in the current housing situation on the housing box DB 225, and the currently operating delivery person or the group of the corresponding delivery person is registered therein as unlocking permitted person. The corresponding housing box is a housing box in which only the currently operating delivery person or the group of the delivery person can deposit a delivery object.

“(C) Unloadable Housing Boxes” refer to the housing box that is “in-use” in the current housing situation on the housing box DB 225, and no one including the currently operating delivery person can deposit a delivery object therein.

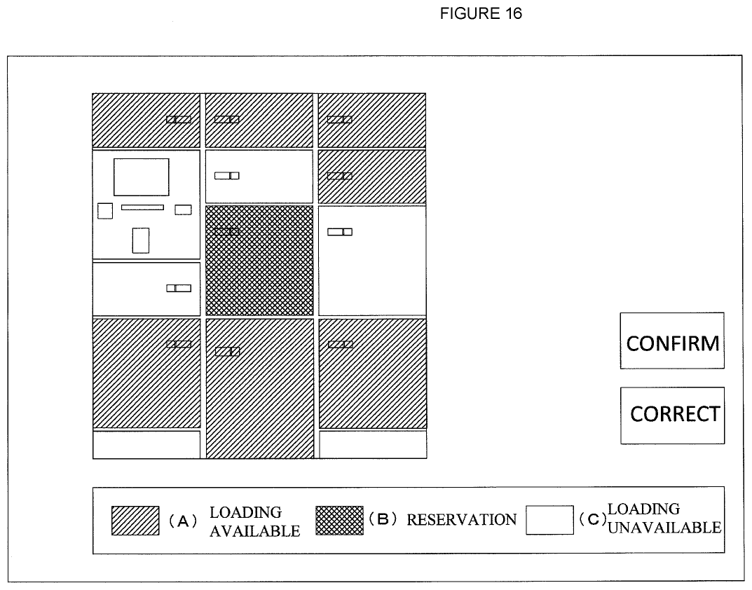

FIG. 16 is a drawing that shows one example of box screen information displayed by the housing device 10 in the first embodiment of the present invention.

In the example shown in the drawing, on the box screen information, housing boxes of the housing device 10 are displayed, and the above-mentioned housing boxes (A) to (C) are displayed with different colors or the like (in the example of the drawing, (A) is indicated by slanting lines, (B) is indicated by slanting lattice shaped lines, and (C) is indicated by white blank sections)

In this case, the delivery person is indicated on the box screen information by using the operation part 15.

From (A) or (B) housing box, desired housing box suitable for characteristics of the delivery object can be selected (step S107).

As described above, when the delivery person selects a housing box in which the delivery object is loaded, the control part 11 allows the corresponding housing box to be unlocked or door-opened (step S108).

The delivery person houses the delivery object in the door-opened housing box, and the door is closed and locked.

When a detection signal indicating that the delivery object is loaded in the corresponding housing box from the delivery object detection sensor, the control part 11 allows the communication part 13 to transmit information indicating that the delivery person has loaded a delivery object into the housing box to the managing server 20 (step S109).

When the communication part 23 of the managing server 20 receives information indicating that the above-mentioned loading has been made from the housing device 10, the control part 21 records information indicating that the corresponding delivery person has loaded a delivery object in the housing box on the loading history DB 224 and the housing box DB 225 (step S110).

More specifically, the control part 21 respectively records time at which the information indicating that the above-mentioned delivery object has been loaded into the housing box, the delivery person ID inputted in step S102 and the exclusively owned-part information inputted in step S103 in the columns of “loading time”, “loading person” and “unlocking permitted person” in the loading history DB 224.

On the other hand, the control part 21 respectively records time at which the information indicating that the above-mentioned delivery object has been loaded into the housing box and the exclusively owned-part information inputted in step S103 in the columns of “loading time” and “unlocking permitted person” on the housing box DB 225, and also rewrites the column of “housing situation” from “unused” into “in-use”.

Moreover, in the case when the delivery object is loaded in the “(B) housing box in reservation” by the delivery person, the control part 21 rewrites the column of “reservation situation” of the housing box DB 225 from “in reservation” to “unreserved”, and also removes the information in the columns of “reservation cancel time” and “reservation person” therefrom.

As described above, the loading operations of the delivery object by the delivery person are completed.

(2) Operations at the Time when User Takes Out Delivery Object

As described above, after the delivery person has loaded the delivery object addressed to the user into the housing box of the housing device 10, the user who knows this by notification of the loading information visits the installation place of the housing device 10, and takes out the delivery object addressed to himself or herself from the above-mentioned housing box.

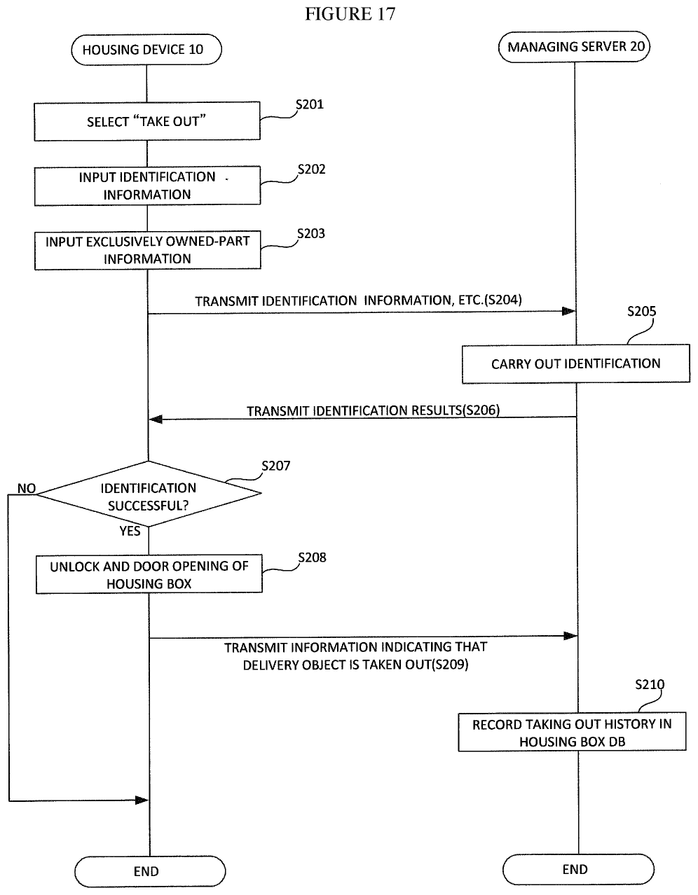

FIG. 17 is a flow chart showing a flow of operations by the housing device 10 at the time when the user takes out the delivery object from the housing device 10 in the first embodiment of the present invention.

Referring to the present drawing, explanation will be given below.

First, the user visits an entrance of condominium houses in which the housing device 10 in which the delivery object addressed to himself or herself is housed is installed.

On the display part 14 of the housing device 10, a start screen for use in selecting the use object of the housing device 10 is displayed.

The start screen displayed in this case may be the same as the start screen shown in FIG. 13.

On the start screen, “take out”, “loading of article”, “collection of article”, “administrator menu” and “reservation” are displayed as the use objects of the housing device 10.

The user selects corresponding one of the plural use objects on the start screen by using the operation part 15 of the housing device 10 (step S201).

In this case, since the user wishes to take out the delivery object addressed to himself or herself from the housing device 10, he or she selects “take out”.

When “take out” is selected as the use object of the housing device 10, the display part 14 displays a message for urging the input of identification information to the user.

Here, the user makes the operation part 15 read identification information from an identification medium of himself or herself, or inputs his or her identification information by using the operation part 15, thereby executing the input of identification information of himself or herself (step S202).

Upon recognition of the input of user identification information, the control part 11 allows the display part 14 to display an input screen of exclusively owned-part information.

In this case, an input screen for order information to be displayed here may be the same as the input screen of exclusively owned-part information shown in FIG. 15.

On the input screen of the exclusively-used part information, an input column for use in inputting the exclusively owned-part information of the user himself or herself is formed.

In this case, the user inputs the exclusively owned-part information in the above-mentioned input column by using the operation part 15 (step S203).

Next, the communication part 13 of the housing device 10 transmits the above-mentioned inputted identification information and exclusively owned-part information to the managing server 20 (step S204).

When the above-mentioned identification information and exclusively owned-part information are received from the housing device 10 by the communication part 13 of the managing server 20, the control part 21 collates identification information in association with the corresponding received exclusively owned-part information with the above-mentioned received identification information in the housing box DB 225 so as to execute an identification process (step S205).

Then, the communication part 23 of the managing server 20 transmits information indicating the identification results to the housing device 10 (step S206).

In the case when the result of identification is successful, the information of the identification result includes a box number of the housing box to be unlocked.

When the communication part 13 of the housing device 10 receives information of the above-mentioned identification result from the managing server 20, the control part 11 determines the corresponding received identification result (step S207).

In the case when the control part 11 determines that the identification is a failure (step S207/No), it completes the operation, as it is, without unlocking the housing box.

On the other hand, in the case when the control part 11 determines that the identification is successful (step S207/Yes), it unlocks and opens the door of the housing box having the box number included in the corresponding identification result (step S208).

The user takes out the delivery object from the housing box whose door is opened.

Upon receipt of a detection signal indicating that the delivery object has been taken out of the housing box from the delivery object detection sensor, the control part 11 allows the communication part 13 to transmit information indicating that the user has taken out the delivery object from the housing box to the managing server 20 together with the information of the box number of the corresponding housing box (step S209).

When the communication part 23 of the managing server 20 receives the information indicating that the above-mentioned delivery object has been taken out and the box number information from the housing device 10, the control part 21 records the fact that the corresponding delivery object has been taken out in the housing box DB 225 (step S210).

More specifically, the control part 21 deletes information of the respective columns (loading time, unlocking permitted person) of the housing box from which the delivery object is taken out on the housing box DB 225, and also rewrites the column of “housing situation” from “in-use” to “unused”.

Thus, the taking-out operations of the delivery object by the user are completed.

(3) Reservation Operations of Housing Box from Delivery Person Terminal 30

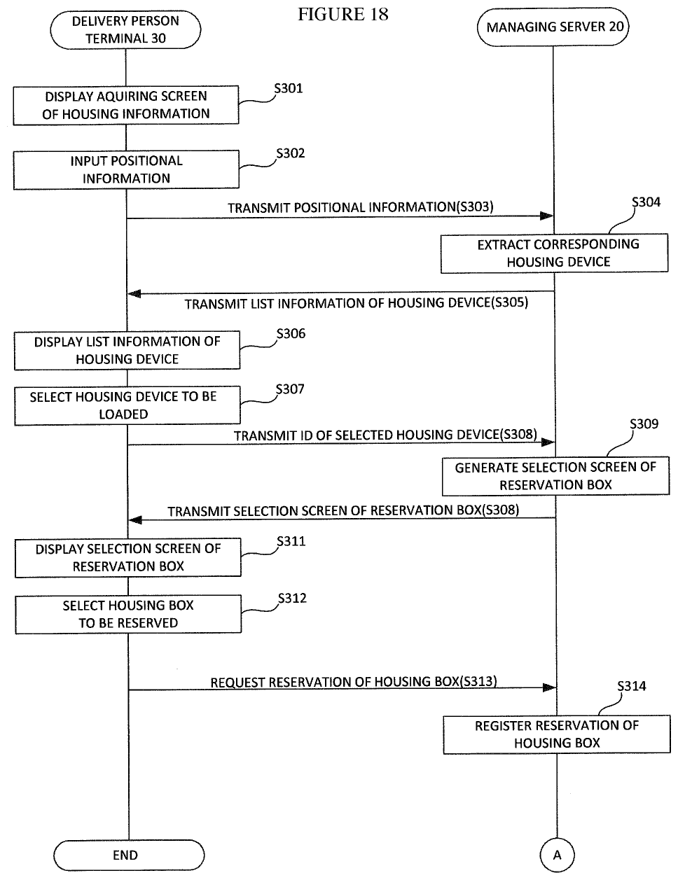

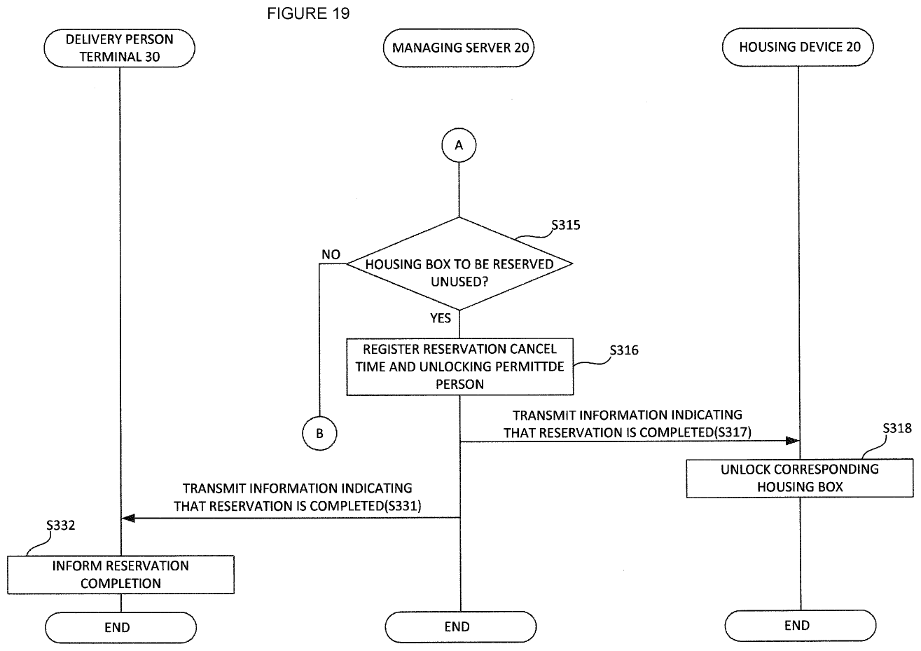

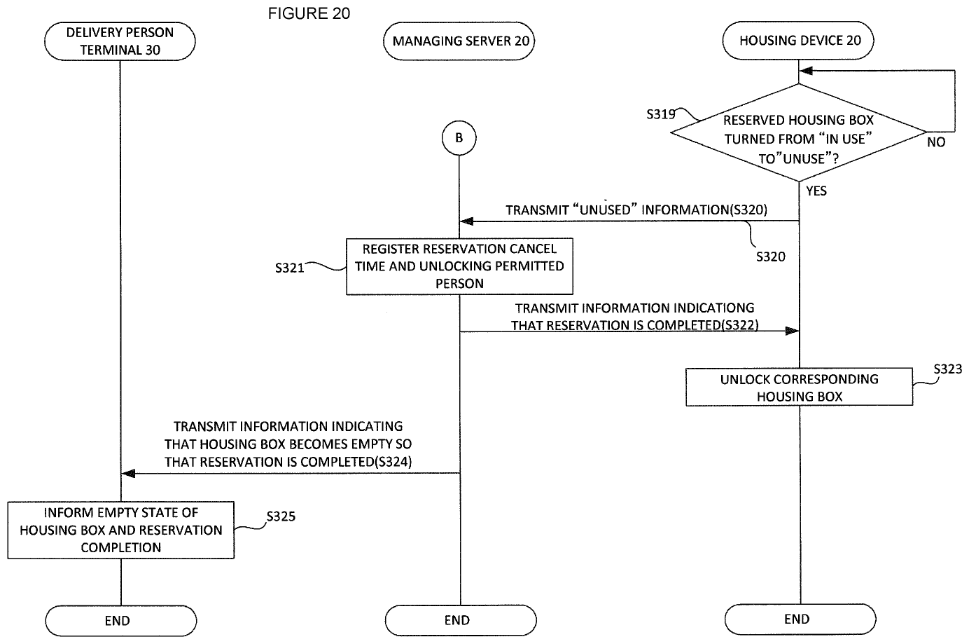

FIGS. 18 to 20 are sequence charts showing a flow of reservation operations of the housing box by the use of delivery person terminal 30 in accordance with the first embodiment of the present invention.

Referring to the present drawing, explanation will be given, for example, on operations of the housing information providing system at the time when a delivery person delivers a delivery object to a resident in condominium houses, by preliminarily operating the delivery person terminal 30 so as to make reservation of a housing box of the housing device 10 serving as a loading end.

First, by operating the operation part 35 of the delivery person terminal 30, the delivery person allows the display part 34 to display an acquiring screen for housing information (step S301).

Next, the delivery person inputs positional information, such as an address, an area or the like, of the corresponding condominium houses, in input columns of positional information of a delivery end of a delivery object formed on the displayed acquiring screen of the housing information (step S302).

In this case, the delivery person may input information capable of specifying the condominium houses of the delivery end, such as, for example, “Urban Apartment o-o-o Shibuya, Shibuya Ward”, or may input Area Name, such as “Shibuya” including the position of the condominium houses, although the condominium houses themselves are not specified.

The communication part 33 of the delivery person terminal 30 transmits the above-mentioned inputted positional information to the managing server 20 (step S303).

When the communication part 33 of the managing server 20 receives the above-mentioned positional information from the delivery person terminal 30, the control part 21 refers to the housing device DB 223, and extracts the housing device 10 placed at the position indicated by the corresponding received positional information (step S304).

The communication part 23 of the managing server 20 transmits list information of the above-mentioned extracted housing devices 10 to the delivery person terminal 30 (step S305).

When the communication part 33 of the delivery person terminal 30 receives the above-mentioned list information of the housing devices 10, the control part 31 displays the received list information of the housing devices 10 on the display part 34 (step S306).

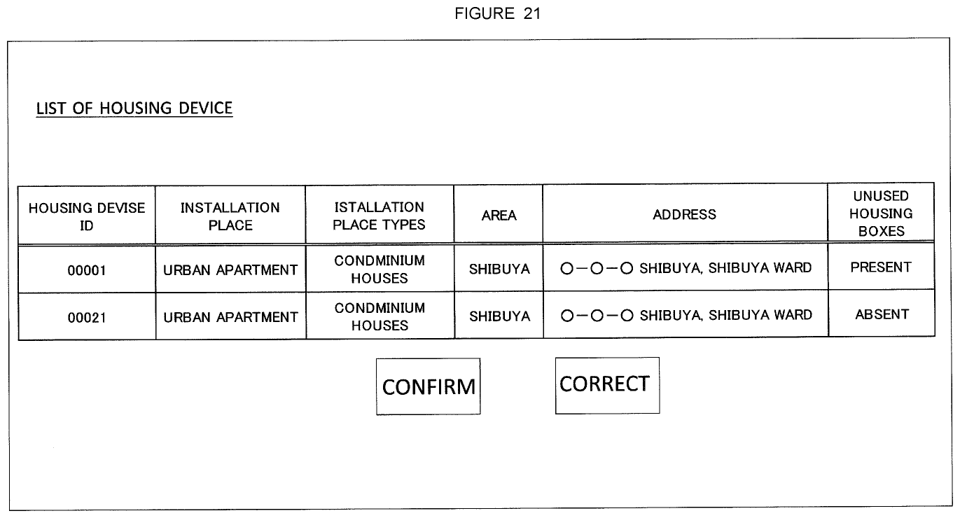

FIG. 21 is a drawing that shows one example of list information of the housing devices 10 in the first embodiment of the present invention.

In the example of the drawing, a list of the housing devices 10 (three housing devices 10) installed in “Urban Apartments” of delivery planning end of the delivery person is displayed, and the presence/absence of unused (empty) housing boxes of the respective housing devices 10 is displayed.

By using the operation part 35, the delivery person selects the housing device 10 to be loaded from one or more housing devices 10 displayed on the display part 34 (step S307).

The communication part 33 of the delivery person terminal 30 transmits the housing device ID of the above-mentioned selected housing device 10 to the managing server 20 (step S308).

When the communication part 23 of the managing server 20 receives the above-mentioned housing device ID from the delivery person terminal 30, the control part 21 refers to the housing box DB 225 of the housing device 10 corresponding to the above-mentioned housing device ID, and generates reservation box selection screen information for use in reserving the housing box of the corresponding housing device 10 (step S309), and transmits the generated reservation box selection screen information to the delivery person terminal 30 (step S310).

When the communication part 32 of the delivery person terminal 30 receives the above-mentioned reservation box selection screen information, the display part 34 displays the received reservation box selection screen information (step S311).

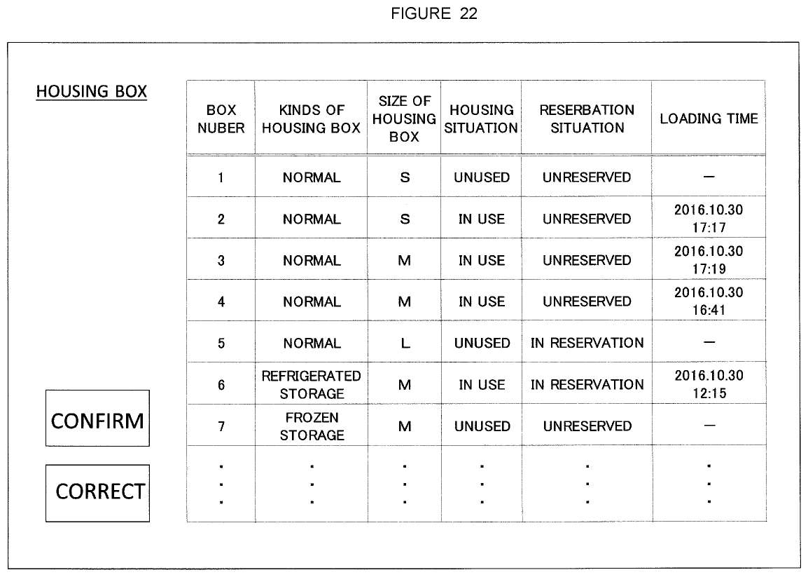

FIG. 22 is a drawing that shows one example of the reservation box selection screen that the delivery person terminal 30 displays in the first embodiment of the present invention.

In the example shown in the drawing, on the reservation box selection screen, a plurality of housing boxes of the housing device 10 are displayed, and the housing situation, kinds, sizes, reservation situation and loading time of each of the housing boxes are displayed.

Additionally, in the reservation box selection screen information, the above-mentioned reservation box selection screen may be designed so that with respect to the housing box whose reservation situation is “in reservation”, the reservation selection cannot be carried out.

In this case, by using the operation part 35, the delivery person selects a desired housing box to be reserved, which is suitable for characteristics of the delivery object from the housing boxes displayed on the reservation box selection screen (step S312).

When the delivery person selects a housing box to be reserved, the communication part 33 of the delivery person terminal 30 transmits the above-mentioned inputted delivery person ID to the managing server 20 together with the information of the box number of the selected housing box and the housing device ID of the corresponding housing device 10 so that the reservation of the corresponding housing box is requested (step S313).

When the communication part 23 of the managing server 20 receives the information of the above-mentioned box number and the housing device ID as well as the delivery person ID from the delivery person terminal 30, the control part 21 reservation-registers the housing box of the corresponding received box number on the housing box DB 225 of the housing device 10 corresponding to the housing device ID (step S314).

More specifically, on the housing box DB 225, with respect to the housing box of the corresponding box number, the control part 21 registers the above-mentioned received delivery person ID as a reservation person, and rewrites the reservation situation from “unreserved” to “in reservation”.

Next, the control part 21 determines whether or not the housing situation of the selected housing box is “unused” (step S315).

In this case, when determined as “unused” (step S315/Yes), the control part 21 starts reservation processes about the housing box having the corresponding box number on the housing box DB 225, and registers it in columns of the reservation cancel time and the unlocking permitted person (step S316).

In the column of the reservation cancel time, the control part 21 sets and registers a period of time elapsed from the time (current time) when, for example, the managing server 20 has received the above-mentioned delivery person ID or the like.

Moreover, in the column of the unlocking permitted person, the control part 21 registers the delivery person ID of the corresponding delivery person or a group ID of a group (delivery company or the like) to which the corresponding delivery person belongs based upon the delivery person DB 222. For example, the control part 21 refers to the delivery person DB 222, and in the case when there is a group ID associated with the above-mentioned received delivery person ID, it registers the group ID in the above-mentioned unlocking permitted person.

Additionally, when the above-mentioned reservation cancel time has been reached, the corresponding reservation is canceled. More specifically, the control part 21 deletes the above-mentioned registered delivery person ID and reservation cancel time, and in the case when the ID of the reserved delivery person or group is registered in the column of the unlocking permitted person, the column of the corresponding unlocking permitted person is also deleted.

When the housing box whose housing situation is “unused” is reservation registered as described above, the communication part 23 of the managing server 20 transmits the box number of the reserved housing box to the housing device 10 that is the reservation target (step S317).

When the communication part 13 of the housing device 10 receives the above-mentioned box number from the managing server 20, the control part 11 locks the corresponding housing box so as to prevent the other persons from using it (step S318).

Next, the managing server 20 transmits information indicating the completion of reservation to the delivery person terminal 30 (step S331).

The information indicating the completion of reservation includes information of the installation position and the box number of the housing box or the like of the above-mentioned reserved housing device 10.

Upon receipt of the above-mentioned information indicating the completion of reservation from the managing server 20, the delivery person terminal 30 displays the contents thereof on the display part 34 or voice-outputs by the voice output part 36 so as to inform the delivery person (step S332).

The delivery person confirms the contents of the reservation completion, and then moves to the installation place of the housing device 10 whose reservation is completed to carry out the delivery business.

As described above, the reservation operation on the housing box whose housing situation is “unused” is completed.

On the other hand, in the case when returning to step S315, the control part 21 determines that the housing situation of the housing box whose reservation is selected is “in-use” (step S315/No), the control part 21 enters a stand-by state until a delivery object has been taken out of the corresponding reserved housing box of the housing device 10 in “in-use” and information (unused information) indicating that its housing situation becomes “in-use” to “unused” has been received from the housing device 10.

In this stage, on the housing box DB 225, with respect to the housing box having the corresponding box number, the control part 21 does not register anything in columns of the reservation cancel time and the unlocking permitted person in this stage.

Additionally, since the corresponding housing box is currently in-use, the ID of the currently working delivery person or the group is registered in the column of the unlocking permitted person of the housing box DB 225.

Thereafter, upon detection that the above-mentioned reserved housing box in “in-use” state becomes “unused” (step S319/Yes), the control part 11 of the housing device 10 allows the communication part 13 to transmit the unused information to the managing server 20 (step S320).

When the managing server 20 receives the above-mentioned unused information from the housing device 10, the control part 21 registers data in columns of the reservation cancel time and the unlocking permitted person about the corresponding housing box (step S321).

In the column of the above-mentioned reservation cancel time, the control part 21 sets and registers time after a passage of a predetermined period of time from the time (current time) at which the managing server 20 has received the above-mentioned unused information.

Moreover, in the column of the unlocking permitted person, the control part 21 registers the delivery person ID of the corresponding delivery person or a group ID of a group (delivery company or the like) to which the corresponding delivery person belongs based upon the delivery person DB 222. For example, the control part 21 refers to the delivery person DB 222, and in the case when there is a group ID in association with the delivery person ID thus received, registers the group ID in the column of the unlocking permitted person.

Additionally, when the above-mentioned reservation cancel time has been reached, the reservation is deleted. More specifically, the control part 21 deletes the above-mentioned registered delivery person ID and reservation cancel time, and in the case when the reserved delivery person or group ID is registered in the column of the unlocking permitted person, the column of the corresponding unlocking permitted person is also deleted.

Next, with respect to the above-mentioned housing box that becomes from the above-mentioned “in-use” to “unused”, the communication part 23 of the managing server 20 transmits information indicating that the reservation registration has been completed to the housing device 10 (step S322).

The above-mentioned information indicating that the reservation registration has been completed includes the box number of the housing box whose reservation has been completed.

When the communication part 13 of the housing device 10 has received the above-mentioned information indicating that the reservation has been completed from the managing server 20, the control part 11 locks the corresponding housing box to prevent from being used by the other persons (step S323).

Next, the managing server 20 transmits information indicating that the reserved housing box “in-use” becomes “used” so that the reservation has been completed to the delivery person terminal 30 (step S324).

The information indicating that the reservation has been completed includes information of the installation position of the reserved housing device 10, the box number of the housing box and the like.

Upon receipt of the information indicating that the reservation has been completed from the managing server 20, the delivery person terminal 30 displays the contents on the display part 34, or voice-outputs by the voice-outputting part 36 so as to inform the delivery person (step S325).

The delivery person confirms the contents of the reservation completion, and then moves to the installation place of the housing device 10 whose reservation is completed to carry out the delivery business.

As described above, reservation operations on the housing box whose housing situation becomes “in-use” to “unused” are completed.

As described above, by using the delivery person terminal 30, the delivery person can confirm the housing situation of the housing device 10 installed in a building or the like of the delivery end, and can reserve the housing box of the corresponding housing device 10; therefore, even when the user of the delivery end is not at home, the delivery object can be positively deposited in the housing box of the housing device 10.

Moreover, even when the user of the delivery end is not at home and when all the housing boxes that are suitable for the characteristics of the delivery object are in-use, the delivery person can make reservation on the corresponding housing box in-use, and the delivery object can be positively deposited in the housing box of the housing device at the time of the next delivery.

Moreover, the managing server 20 may inform the delivery person terminal 30 of the fact that reservation cancel time comes closer a predetermined period of time before the arrival of the reservation cancel time so that the delivery person is urged so as to deposit a delivery object or the like quickly.

By informing to the delivery person terminal 30 in this manner, the reservation thereof is forcefully canceled so that the delivery person is prevented from failing to deposit the delivery object.

In the case when the delivery person carries out reservation on a housing box in-use and when a delivery object is then taken out of the corresponding housing box so that the housing situation becomes from “in-use” to “unused”, the managing server 20 may inform the delivery person terminal 30 of the fact that the housing of the delivery object becomes available.

In this manner, by informing the delivery person terminal 30 of the fact, it becomes possible to prevent the delivery person from having such a wasteful action that although he or she visits the delivery end, the delivery object needs to be brought back because the housing box is not empty.

(4) Reservation Operations of Housing Box from Housing Device 10

As described above, the delivery person makes it possible to reserve a housing box of the housing device 10 by using the delivery person terminal 30. That is, in the case when the delivery person delivers a delivery object at this time, or when the user of the delivery end is not at home, and no housing box suitable for the delivery object is present, the reservation is carried out by using the delivery person terminal 30.

In addition to this, when the user of the delivery end is not at home and no housing box suitable for the delivery object is present, the delivery person directly operates the operation part 15 of the housing device 10 so that the reservation of the housing box in-use of the housing device 10 can be made.

Moreover, by directly operating the operation part 15 of the housing device 10, the delivery person can carry out the reservation of the housing box in unused.

Since with respect to the housing box in unused, a delivery object can be loaded at that site, the reservation of the corresponding unused housing box is considered to be unnecessary; however, by carrying out reservation in the following cases, the delivery business of the delivery person can be reduced.

For example, in the case when the delivery person plans to again visit the currently visiting delivery end or when another delivery person belonging to the same group (colleague or the like of the delivery company) plans to again visit the place, by reserving the housing box in unused, it becomes possible to efficiently carry out the delivery business when the delivery person or another delivery person visits the same place next time.

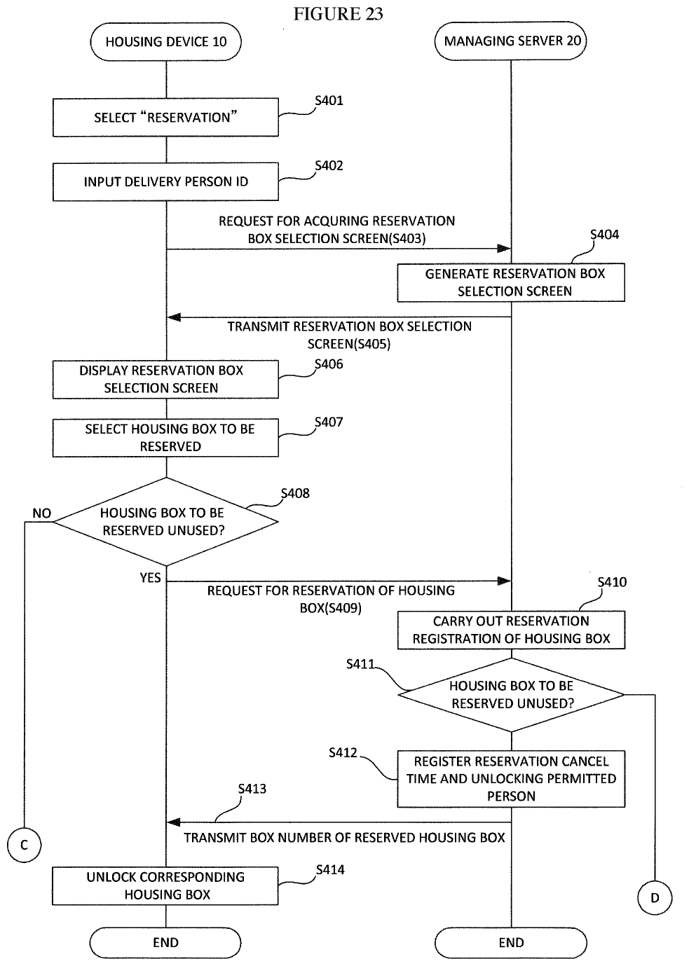

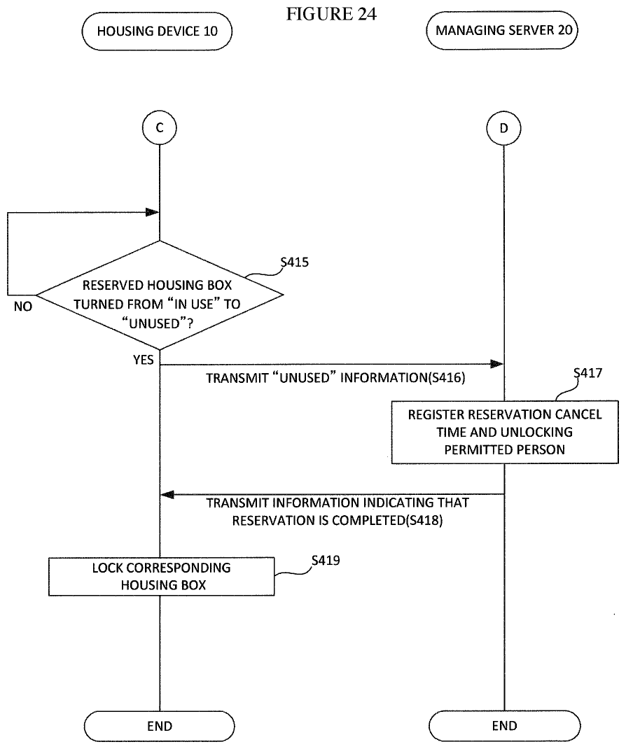

FIGS. 23 and 24 are sequence charts showing a flow of reserving operations of a housing box by using the housing device 10 in the first embodiment of the present invention.

Referring to the present drawings, for example, explanation will be given on operations by the housing information providing system that are preliminarily carried out by directly operating the housing device 10 at the time of reserving a housing box, when a delivery person delivers a plurality of delivery objects to residents of condominium houses.

In the case when a delivery person cannot directly deliver a delivery object to a user because the user in the delivery end is not at home, the delivery person deposits the corresponding delivery object to a housing device 10 of a building or the like of the delivery end.

In this case, when a housing box suitable for the size and contents (refrigerating required, freezing required, or the like) of a delivery object is in-use, a delivery person has to bring back the delivery object; however, reservation of the corresponding housing box may be made so as to positively deposit the delivery object in the housing box when the user of the delivery end is not at home at the time of the next delivery process.

On the display part 14 of the housing device 10, a start screen for use in selecting a use object for the housing device 10 as shown in FIG. 13 is displayed.

For example, by operating the operation part 15 of the housing device 10, a delivery person selects “Reservation” from a plurality of use objects on the start screen (step S401).

When “Reservation” is selected as the use object for the housing device 10, the display part 14 displays an input screen for the delivery person ID.

In this case, by using the operation part 15, the delivery person inputs the delivery person ID of himself or herself in the input column on the input screen of the delivery person ID (step S402).

When the delivery person ID is inputted, the communication part 13 of the housing device 10 transmits an acquiring request for screen information (reservation box selection screen information) for use in selecting the housing box of a reservation target to the managing server 20 (step S403).

When the communication part 23 of the managing server 20 receives the acquiring request for the above-mentioned reservation box selection screen from the housing device 10, the control part 21 refers to the housing box DB 225, and generates the above-mentioned reservation box selection screen information (step S404), and then transmits the reservation box selection screen information thus generated to the housing device 10 (step S405).

When the communication part 12 of the housing device 10 receives the above-mentioned reservation box selection screen information, the display part 14 displays the received reservation box selection screen information (step S406).

The present reservation box selection screen information may be designed to have the same configuration as the example shown in FIG. 22.

Additionally, in the reservation box selection screen information, with respect to the housing box whose reservation situation is “in reservation”, the reservation box selection screen may be designed so as not to carry out reservation selection.

In this case, by using the operation part 15, the delivery person selects a desired housing box to be reserved, which is suitable for the characteristics of a delivery object from the housing boxes displayed on the reservation box selection screen (step S407).

In the case when the selected housing box is determined to be “unused” (step S408/Yes), the control part 11 of the housing device 10 allows the communication part 13 of the housing device 10 to transmit the above-mentioned inputted delivery person ID to the managing server 20 together with the information of the box number of the selected housing box and the housing device ID of the corresponding housing device 10, so as to request for the reservation of the corresponding housing box (step S409).

When the communication part 23 of the managing server 20 receives the information of the above-mentioned box number, the housing device ID and the delivery person ID from the housing device 10, the control part 21 reservation-registers the housing box of the received box number on the housing box DB 225 corresponding to the housing device ID (step S410).

More specifically, the control part 21 registers the received delivery person ID as a reserved person about the housing box of the corresponding box number on the housing box DB 225, and rewrites the reservation situation from “unreserved” to “in reservation”.

Next, the control part 21 determines whether the housing situation of the above-mentioned selected housing box is “unused” or not (step S411).

Upon determination as “unused” (step S411/Yes), the control part 21 registers the housing box of the corresponding box number in the columns of the reservation cancel time and the unlocking permitted person on the housing box DB 225 (step S412).

The control part 21 sets and registers time after the passage of a predetermined time from the time (current time) at which, for example, the managing server 20 has received the above-mentioned delivery person ID or the like in the column of the above-mentioned reservation cancel time.

Moreover, in the column of the unlocking permitted person, the control part 21 registers the delivery person ID of the corresponding delivery person or a group ID of a group (delivery company or the like) to which the corresponding delivery person belongs based upon the delivery person DB 222. For example, the control part 21 refers to the delivery person DB 222, and in the case when a group ID in association with the delivery person ID is present, it registers the group ID in the column of the above-mentioned unlocking permitted person.

Additionally, when the above-mentioned reservation cancel time has reached, the corresponding reservation is canceled. More specifically, the control part 21 removes the above-mentioned registered delivery person ID and reservation cancel time, and in the case when the ID of the reserved delivery person or group is registered in the column of the unlocking permitted person, the column of the corresponding unlocking permitted person is also removed.

When the housing box whose housing situation is “unused” is reservation registered as described above, the communication part 23 of the managing server 20 transmits the box number of the reserved housing box to the housing device 10 that is the reservation target (step S413).

When the communication part 13 of the housing device 10 receives the above-mentioned box number from the managing server 20, the control part 11 locks the corresponding housing box so as to prevent the other persons from using it (step S414).

As described above, reservation operations on the housing box whose housing situation is “unused” are completed.

On the other hand, in step S408 and step S411, when the control part 11/21 determines that the housing situation of the housing box the reservation of which is selected is “in-use” (step S408/No, step S411/No), the control part 21 enters a stand-by state until the above-mentioned unused information has been received from the housing device 10.

In this stage, on the housing box DB 225, with respect to the housing box having the corresponding box number, the control part 21 does not register anything in columns of the reservation cancel time and the unlocking permitted person in this stage.

Additionally, since the corresponding housing box is currently in-use, the ID of the currently working delivery person or the group is registered in the column of the unlocking permitted person of the housing box DB 225.

Thereafter, upon detection that the above-mentioned reserved housing box in “in-use” becomes “unused” (step S415/Yes), the control part 11 of the housing device 10 allows the communication part 13 to transmit the unused information to the managing server 20 (step S416).

When the managing server 20 receives the above-mentioned unused information from the housing device 10, the control part 21 registers in columns of the reservation cancel time and the unlocking permitted person about the corresponding housing box (step S417).

In the column of the above-mentioned reservation cancel time, the control part 21 sets and registers time after a passage of a predetermined period of time from the time (current time) at which the managing server 20 has received the above-mentioned unused information.

Moreover, in the column of the unlocking permitted person, the control part 21 registers the delivery person ID of the corresponding delivery person or a group ID of a group (delivery company or the like) to which the corresponding delivery person belongs based upon the delivery person DB 222. For example, the control part 21 refers to the delivery person DB 222, and in the case when there is a group ID in association with the delivery person ID thus received, registers the group ID in the column of the unlocking permitted person.

Additionally, when the above-mentioned reservation cancel time has been reached, the reservation is deleted. More specifically, the control part 21 deletes the above-mentioned registered delivery person ID and the reservation cancel time, and in the case when the reserved delivery person or group ID is registered in the column of the unlocking permitted person, the column of the corresponding unlocking permitted person is also deleted.

Next, with respect to the above-mentioned housing box that becomes from the “in-use” to “unused”, the communication part 23 of the managing server 20 transmits information indicating that the reservation registration has been completed to the housing device 10 (step S418).

The above-mentioned information indicating that the reservation registration has been completed includes the box number of the housing box whose reservation has been completed.

When the communication part 13 of the housing device 10 has received the above-mentioned information indicating that the reservation has been completed from the managing server 20, the control part 11 locks the corresponding housing box to prevent from being used by the other persons (step S419).

As described above, reservation operations on the housing box whose housing situation becomes “in-use” to “unused” are completed.

As described above, by directly operating the housing device 10 installed in the building or the like of the delivery end, the delivery person can confirm the housing situation of the corresponding housing device 10, and carry out the reservation of a housing box of the housing device 10; therefore, even when the user of the delivery end is not at home, the delivery object can be deposited in a housing box of the housing device 10 at this time, or can be positively deposited at the next delivery time.

Moreover, even when the user of the delivery end is not at home and all the delivery boxes suitable for the delivery object are in-use, the delivery person can make reservation also on the housing box currently in-use so that the delivery object can be positively deposited at the next delivery time.

Furthermore, in the case when by directly operating the operation part 15 of the housing device 10, the delivery person makes reservation of a housing box also, in the same manner as in the case of making reservation by operating the delivery person terminal 30, prior to a predetermined time before the above-mentioned reservation cancel time has been reached, or when the usage situation of the reserved housing box changes from “in-use” to “unused” the managing server 20 informs the delivery person terminal 30 of this fact.

Therefore, even when the user in the delivery end is not at home, the delivery person can positively deposit the delivery object in the housing device 10, thereby making it possible to prevent the necessity of re-delivery.

### Summary of Embodiments

### Summary of First Embodiment

In accordance with the housing information providing system as described above in the first embodiment of the present invention, prior to delivering to the delivery end, the delivery person can preliminarily acquire the housing situation of the housing box of the housing device 10 from the managing server 20 by using the delivery person terminal 30 or the like, on the assumption that the user of the delivery end is not at home, such a delivery schedule as to positively deposit the delivery object in the housing device 10 can be easily formed.

Moreover, in accordance with the present embodiment, by using the delivery person terminal 30, or by directly operating the housing device 10 installed in the delivery end, the delivery person can make the reservation of the housing box of the housing device 10, such a delivery schedule as to positively deposit the delivery object in the housing device 10 can be easily formed.

In general, the delivery person mounts delivery objects on a vehicle, and by temporarily parks the vehicle at a parking lot or a road side, he or she delivers the delivery object to the building of the delivery end.

In the case of large condominium houses, there are many cases in which from the parking place to the building of the delivery end, there is a certain distance. In this case, when the user of the delivery end is not at home, with no empty housing box of the housing device 10 being present, the delivery person needs to reciprocally carry the delivery object between the parking place and the building, thereby causing a big load to the delivery person.

By utilizing the housing information providing system in the present embodiment, it becomes possible for the delivery person to reduce such transporting work of the delivery object between the parking place and the building, and consequently to realize efficient operations in the entire delivery business.

Moreover, in accordance with the present embodiment, the reservation process (so-called tentative reservation) can be carried out not only on the currently unused housing box, but also on the housing box in-use in the housing device 10; therefore, the delivery person can use even a housing box that has a high use frequency and is difficult to reserve, and it becomes possible to effectively reduce time-consuming re-delivery operations.

Furthermore, in accordance with the present embodiment, in the case when the reservation cancel time has been reached, since the housing device 10 forcefully cancels, the reservation of the housing box, the housing box can be efficiently used without being kept in the unused state for a long period of time.

The above-mentioned housing device 10, managing server 20 and delivery person terminal 30 can be realized by mainly a CPU, as well as programs loaded into a memory. However, these device and server can be constituted by combinations of the other desired hardware and software, and its high degree of freedom in designing can be easily understood by a person skilled in the art.

Moreover, in the case when the above-mentioned housing device 10, managing server 20 or delivery person terminal 30 are constituted as a group of software modules, these programs may be recorded on a recording medium, such as an optical recording medium, a magnetic recording medium, a magneto-optical recording medium or a semiconductor, and may be loaded from the above-mentioned recording medium, or may be loaded from an external apparatus connected through a predetermined network.

Additionally, the above-mentioned embodiments are merely examples of desirable embodiments of the present invention, and the embodiments of the present invention are not intended to be limited thereby, and various modifications may be made therein within the scope without departing from the gist of the present invention.

For example, in the above-mentioned embodiment, the managing server 20 is provided with respective data bases 221 to 225, and refers to the respective data bases 221 to 225 so that respective processes, such as identification, information providing and reservation registering processes, are executed; however, the housing device 10 may be provided with data bases for managing information having the same contents as those of data bases 221 to 225, and the housing device 10 itself may execute the respective processes in place of the managing server 20.

Moreover, both of the housing device 10 and the managing server 20 respectively have data bases for managing information having the same contents, and the housing device 10 and the managing server 20 may be made synchronous with each other so as to share information inside the data base.

In the above-mentioned embodiment, by allowing the control part 31 to execute applications (software) installed (packaged) in the information storage part 32, the delivery person terminal 30 is designed to confirm the housing situation of the housing boxes, and also to execute reservation of the housing boxes; and the above-mentioned applications may be widely used information browsing software, that is, for example, a browser.

In this case, by using the delivery person terminal 30, the delivery person displays a housing situation confirming Web site of housing boxes or a reservation-use Web site of housing boxes through a browser. Although a Web server for managing the Web site is not particularly limited, the following explanation is given by exemplifying the managing server 20.

By using the delivery person terminal 30, the delivery person inputs predetermined information on the corresponding Web side, so as to transmit acquiring request for information (screen) relating to confirmation or reservation of the housing situation of the housing boxes to the managing server 20.

In response to the above-mentioned acquiring request for information, the managing server 20 transmits the corresponding information to the delivery person terminal 30 in a data format (HTML) of Web pages.

As the information to be transmitted by the managing server 20 to the delivery person terminal 30 in the Web page format, those pieces of information include, for example, an acquiring screen for housing information, a list of information of the housing device 10, reservation box selection screen information, information indicating that reservation completion, and the like.

In this manner, the delivery person carries out confirmation of the housing situation of housing boxes and reservation of the housing boxes even on the browser.

In the operations of step S324 in the above-mentioned embodiment, when the use state of the housing boxes becomes from in-use to unused so as to complete the reservation, the managing server 20 transmits the information indicating the completion of reservation to the delivery person terminal 30; however, even in the case of no reservation accompanied, only the fact that the use state of the housing boxes becomes from in-use to unused may be informed to the delivery person terminal 30.

In this case, after specifying the housing device 10 and housing box, by using the delivery person terminal 30 in the same manner as in the reservation time, the delivery person transmits a notification request at the time when the specified housing box becomes the unused state to the managing server 20, and the managing server 20 stores the corresponding notification request in the information storage part 22.

In the same manner as in the operation at the above-mentioned reservation time, when it is recognized that the housing box specified by the delivery person becomes unused by receiving information in unused from the housing device 10, the managing server 20 transmits the information indicating that the specified housing box becomes the unused (empty) state to the delivery person terminal 30, and the delivery person terminal 30 displays the corresponding notification contents or voice-outputs so as to notify the delivery person.

Moreover, upon receipt of information indicating that the reservation has been completed or information indicating that the housing box becomes the unused state from the managing server 20, the delivery person terminal 30 inform the delivery person of the contents of the received information by a screen display or a voice output; however, the corresponding informing process may be executed by operating the operation part 35 by the delivery person, or may be automatically executed when the delivery person terminal 30 receives the corresponding information.

For example, in the case when the informing process is executed automatically by a screen display or a voice output as described above, even in such a case when the delivery person is driving a vehicle for delivery so that the hands have to be put on the handle, and the delivery person terminal 30 cannot be operated, it becomes possible to easily confirm the contents of the information.

### EXPLANATION OF REFERENCE NUMERALS

10 housing device
11, 21, 31 control part
12, 22, 32 information storage part
13, 23, 33 communication part
14, 34 display part
15, 35 operation part
20 managing server
30 delivery person terminal
36 voice output part
100 network
221 user DB
222 delivery person DB
223 housing device DB
224 loading history DB
225 housing box DB
1611 housing chamber
1612 loading/unloading opening
1613 door
1614 locking/unlocking part
1615 article detection part
1617 hinge part
1618 hook
1619 hook hole

What is claimed is:

1. A housing information providing system comprising:
a housing device that includes one or more housing boxes and temporarily receives delivery objects by housing the delivery objects in the housing boxes;
a management server for managing information in the housing boxes; and
a delivery person terminal for use in delivering delivery objects,
wherein the managing server transmits information about the housing situation and reservation situation of the housing boxes of the housing device to the delivery person terminal.

2. The housing information providing system according to claim 1, wherein upon receipt of information for requesting reservation of a housing box of the housing device from the delivery person terminal, the managing server carries out the reservation process of the housing box whose reservation is requested, and in the case of unused state of the housing box, locks the housing box so as to inhibit the storing of a delivery object.

3. The housing information providing system according to claim 1, wherein upon receipt of information for requesting reservation of a housing box of the housing device from the housing device, the managing server carries out the reservation process of the housing box whose reservation is requested, and in the case of unused state of the housing box, locks the housing box so as to inhibit the storing of a delivery object.

4. The housing information providing system according to claim 2, wherein after passage of a predetermined period of time from the reservation process, the managing server cancels the reservation process of the housing box relating to the reservation process so as to unlock the housing box.

5. The housing information providing system according to claim 1, wherein upon receipt of information for requesting reservation of a housing box of the housing device from the delivery person terminal, the managing server carries out the reservation process of the housing box whose reservation is requested, and in the case of used state of the housing box, when the housing box is brought into an unused state, transmits information indicating the unused state of the housing box to the delivery person terminal.

6. The housing information providing system according to claim 1, wherein upon receipt of information for requesting reservation of a housing box of the housing device from the housing device, the managing server carries out the reservation process of the housing box whose reservation is requested, and in the case of used state of the housing box, when the housing box is brought into the unused state, transmits information indicating the unused state of the housing box to the delivery person terminal.

7. The housing information providing system according to claim 5, wherein after the passage of a predetermined period of time from the time when the housing box whose reservation process is carried out during the used state thereof is brought into the unused state, the managing server cancels the reservation process of the housing box subjected to the reservation process so as to unlock the housing box.

8. The housing information providing system according to claim 3, wherein after passage of a predetermined period of time from the reservation process, the managing server cancels the reservation process of the housing box relating to the reservation process so as to unlock the housing box.

9. The housing information providing system according to claim 6, wherein after the passage of a predetermined period of time from the time when the housing box whose reservation process is carried out during the used state thereof is brought into the unused state, the managing server cancels the reservation process of the housing box subjected to the reservation process so as to unlock the housing box.
